(19) United States
(12) Patent Application Publication
(10) Pub. No.: US 2021/0120506 A1
(43) Pub. Date: Apr. 22, 2021

(54) USER TERMINAL AND RADIO COMMUNICATION METHOD

(71) Applicant: NTT DOCOMO, INC., Tokyo (JP)

(72) Inventors: Daiki Takeda, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 16/634,404

(22) PCT Filed: Jul. 28, 2017
(86) PCT No.: PCT/JP2017/027574

§ 371 Date: Jan. 27, 2020

(51) Int. Cl. H04W 56/00; H04W 48/16; H04L 5/00

(52) U.S. Cl. CPC H04W 56/001; H04L 5/0048; H04W 48/16

(57) ABSTRACT

A user terminal is disclosed including a reception section that receives a Synchronization Signal (SS) block including a synchronization signal and a broadcast channel and a control section that specifies SS block identification information based on at least a sequence of a first reference signal and a sequence of a second reference signal. The sequence of the first reference signal being a sequence to be allocated to a first symbol, and being generated based on cell identification information for identifying a cell and a first part of the SS block identification information for identifying the SS block. The sequence of the second reference signal being a sequence to be allocated to a second symbol, being generated based on the cell identification information for identifying the cell and a second part of the SS block identification information, and being different from the sequence of the first reference signal.

### TECHNICAL FIELD

The present invention relates to a user terminal and a radio communication method of a next-generation mobile communication system.

### BACKGROUND ART

In Universal Mobile Telecommunications System (UMTS) networks, for the purpose of higher data rates and lower latency, Long Term Evolution (LTE) has been specified (Non-Patent Literature 1). Furthermore, for a larger capacity and higher sophistication than those of LTE (LTE Rel. 8 and 9), LTE-Advanced (LTE-A or LTE Rel. 10, 11, 12 and 13) has been specified.

LTE successor systems (also referred to as, for example, Future Radio Access (FRA), the 5th generation mobile communication system (5G), 5G+(plus), New Radio (NR), New radio access (NX), Future generation radio access (FX) or LTE Rel. 14, 15 or subsequent releases) have been also studied.

In legacy LTE systems (e.g., LTE Rel. 8 to 13), a user terminal (UE: User Equipment) detects synchronization signals (a Primary Synchronization Signal (PSS) and/or a Secondary Synchronization Signal (SSS)) by an initial access procedure (also referred to as cell search), synchronizes with a network (e.g., a base station (eNB: eNode B)), and identifies a cell (i.e., identifies the cell based on, for example, a cell Identifier (ID)) to connect with.

Furthermore, after cell search, the user terminal receives a Master Information Block (MIB) transmitted on a broadcast channel (PBCH: Physical Broadcast Channel) or a System Information Block (SIB) transmitted on a Downlink (DL) shared channel (PDSCH: Physical Downlink Shared Channel), and obtains configuration information (that may be referred to as broadcast information or system information) for communicating with a network.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

### SUMMARY OF INVENTION

### Technical Problem

It has been studied for a future radio communication system (e.g., NR or 5G) to define a resource unit including a synchronization signal (also referred to as, for example, a PSS and/or an SSS, or an NR-PSS and/or an NR-SSS) and a broadcast channel (also referred to as a PBCH or an NR-PBCH) as a Synchronization Signal (SS) block, and make an initial access based on the SS block.

According to the initial access based on the SS block, a user terminal is assumed to derive a time index for timing identification based on identification information of the SS block (SS block identification information). In this regard, the time index only needs to be at least one of, for example, a number of a radio frame (also referred to as, for example, a radio frame number or a radio frame index), a number of a slot (also referred to as, for example, a slot number or a slot index) in the radio frame, a number of a symbol (also referred to as, for example, a symbol number or a symbol index) in the slot, a frame number (also referred to as, for example, a System Frame Number (SFN)) in a transmission time interval (also referred to as, for example, a TTI or a PBCH TTI) of an NR-PBCH, and a number indicating a first part or a second part in the radio frame.

Thus, the future radio communication system that is assumed to use the SS block identification information to derive the time index is demanded to indicate the SS block identification information to the user terminal with high reliability and/or low complexity.

The present invention has been made in light of this point, and one of objects of the present invention is to provide a user terminal and a radio communication method that can specify SS block identification information with high reliability and/or low complexity.

### Solution to Problem

A user terminal according to one aspect of the present invention includes: a reception section that receives a Synchronization Signal (SS) block including a synchronization signal and a broadcast channel; and a control section that specifies SS block identification information based on at least a sequence of a first reference signal and a sequence of a second reference signal, the sequence of the first reference signal being a sequence to be allocated to a first symbol, and being generated based on cell identification information for identifying a cell, and a first part of the SS block identification information for identifying the SS block, and the sequence of the second reference signal being a sequence to be allocated to a second symbol, being generated based on the cell identification information for identifying the cell, and a second part of the SS block identification information, and being different from the sequence of the first reference signal.

### Advantageous Effects of Invention

According to the present invention, it is possible to specify SS block identification information with high reliability and/or low complexity.

### BRIEF DESCRIPTION OF DRAWINGS

FIGS. 1A to 1C are diagrams illustrating one example of a configuration of an SS block.

FIG. 2 is a diagram illustrating one example of multiplexing of a DMRS of an NR-PBCH.

FIGS. 3A and 3B are diagrams illustrating one example of an SS burst set.

FIG. 4 is a diagram illustrating one example of indication of an SS block index.

FIG. 5 is a diagram illustrating one example of indication of an SS block index according to a first aspect.

FIG. 6 is a diagram illustrating one example of indication of a 2-bit SS block index.

FIGS. 7A and 7B are diagrams illustrating one example of indication of an SS block index that uses a gold sequence according to the first aspect.

FIG. 8 is a diagram for explaining subcarrier shift of a DMRS in 1 symbol.

FIG. 9 is a diagram illustrating one example of indication of a 3-bit SS block index according to the second aspect.

FIG. 10 is a diagram illustrating one example of indication of an SS block index according to a third aspect.

FIG. 11 is a diagram illustrating one example of indication of an SS block index according to a fourth aspect.

FIG. 12 is a diagram illustrating one example of a schematic configuration of a radio communication system according to the present embodiment.

FIG. 13 is a diagram illustrating one example of an overall configuration of a radio base station according to the present embodiment.

FIG. 14 is a diagram illustrating one example of a function configuration of the radio base station according to the present embodiment.

FIG. 15 is a diagram illustrating one example of an overall configuration of a user terminal according to the present embodiment.

FIG. 16 is a diagram illustrating one example of a function configuration of the user terminal according to the present embodiment.

FIG. 17 is a diagram illustrating one example of hardware configurations of the radio base station and the user terminal according to the present embodiment.

### DESCRIPTION OF EMBODIMENTS

It has been studied for future radio communication systems (e.g., LTE. 14, 15 and subsequent releases, 5G and NR that will be also referred to as NR below) to define a resource unit including at least a synchronization signal and a broadcast channel as a Synchronization Signal (SS) block, and perform communication (e.g., initial access) by using SS blocks.

The SS block may include at least, for example, a Primary Synchronization Signal (also referred to as, for example, a PSS, an NR-PSS, a first synchronization signal or a first synchronization channel) and/or a Secondary Synchronization Signal (also referred to as, for example, an SSS, an NR-SSS, a second synchronization signal or a second synchronization channel), and a broadcast channel (also referred to as, for example, a PBCH: Physical Broadcast Channel, an NR-PBCH, a broadcast signal, a Master Information Block (MIB) or system information). In addition, a synchronization signal (e.g., TSS: Tertiary SS) different from the PSS and the SSS may be included in the SS block. The NR-PSS and/or the NR-SSS will be also referred to as an NR-PSS/SSS below.

Furthermore, the SS block includes one or more symbols (e.g., OFDM symbols). More specifically, the SS block may include a plurality of contiguous symbols. In the SS block, the NR-PSS, the NR-SSS and the NR-PBCH may be arranged on one or more different symbols. For example, it has been also studied for the SS block that the SS block includes 4 symbols including 1 symbol for an NR-SSS, 1 symbol for an NR-SSS and of 2 symbols for an NR-PBCH.

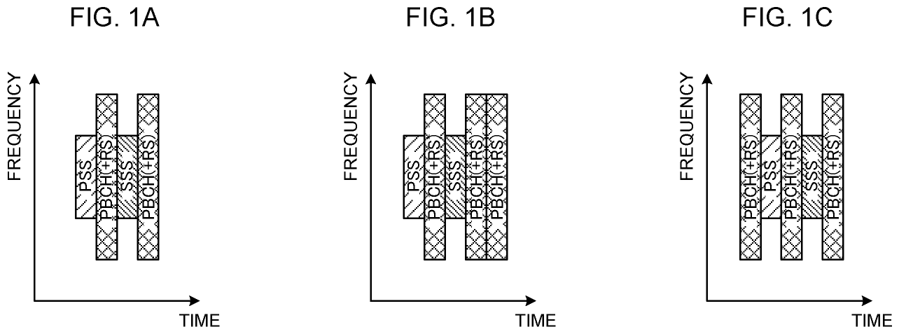

FIG. 1 is a diagram illustrating one example of a configuration of an SS block. In addition, although FIG. 1A illustrates an SS block including 4 symbols, the configuration of the SS block is not limited to those illustrated in FIG. 1A. For example, the NR-PBCH may be arranged on 3 or more symbols, and an SS block may include 5 or more symbols (FIGS. 1B and 1C).

An arrangement order of an NR-PSS (PSS), an NR-SSS (SSS) and an NR-PBCH in the SS block may be an order of the NR-PSS, the NR-PBCH, the NR-SSS and the NR-PBCH as illustrated in FIG. 1, and only 2 symbols of the NR-PBCH may be arranged (FIG. 1A), may be an order of the NR-PSS, the NR-PBCH, the NR-SSS, the NR-PBCH and the NR-PBCH by arranging the additional NR-PBCH (FIG. 1B), or may be an order of the NR-PBCH, the NR-PSS, the NR-PBCH, the NR-SSS and the NR-PBCH (FIG. 1C).

The NR-PBCH may be distributed to and arranged on 1 symbol after the NR-PSS and 1 symbol after the NR-SSS (FIG. 1A). Alternatively, the NR-PBCH may be distributed to and arranged on 1 symbol after the NR-PSS and 2 contiguous symbols after the NR-SSS (FIG. 1B). Alternatively, the NR-PBCH may be distributed to and arranged on 1 symbol before the NR-PSS, 1 symbol between the NR-PSS and the NR-SSS and 1 symbol after the NR-SSS (FIG. 1C).

As illustrated in FIGS. 1A to 1C, the NR-PSS/SSS and the NR-PBCH may be arranged (mapped) in frequency-domains (or frequency bands) of different bandwidths (the different numbers of resource blocks). For example, the NR-PSS/SSS may be mapped in a first frequency-domain (e.g., 127 sequences (or 127 subcarriers)), and the NR-PBCH may be mapped in a second frequency-domain (e.g., 288 subcarriers) wider than the first frequency-domain.

In this case, the NR-PSS/SSS may be each mapped on 127 subcarriers×1 symbol, and the NR-PBCH may be mapped on 288 subcarriers×2 symbols. Furthermore, a reference signal (referred to as, for example, a DeModulation Reference Signal or a DMRS) used to demodulate the NR-PBCH may be mapped in the second frequency-domain. In addition, frequency-domains (e.g., the numbers of subcarriers) that compose the NR-PSS/SSS and the NR-PBCH are not limited to the above value.

Furthermore, the first frequency-domains in which the NR-PSS/SSS are mapped and a second frequency-domain in which the NR-PBCH is mapped may be arranged at least partially overlapping each other. For example, the first frequency-domains and the second frequency-domain may be arranged such that center frequencies of the NR-PSS, the NR-SSS and the NR-PBCH match. Consequently, a UE can reduce a frequency-domain in which reception processing is performed on the SS block during, for example, an initial access (also referred to as, for example, cell search).

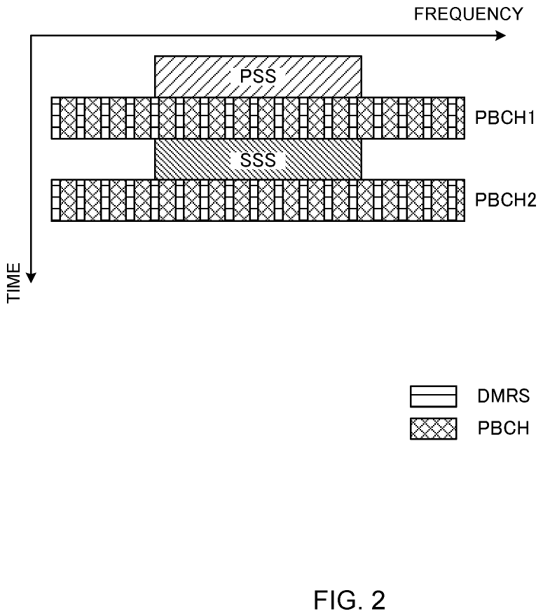

FIG. 2 is a diagram illustrating one example of multiplexing of a DMRS of an NR-PBCH. In addition, in FIG. 2, the configuration illustrated in FIG. 1A is applied to an SS block. However, another configuration (e.g., a configuration illustrated in FIG. 1B or 1C) may be applied in a case where the NR-PBCH is arranged on 3 symbols.

In FIG. 2, sequences of the DMRSs (DMRS sequences) are mapped at frequency positions (e.g., subcarriers) of an equal interval in arrangement symbols of the NR-PBCH in the SS block. For example, a mapping rate of the DMRS sequence and the NR-PBCH in 1 symbol may be 1:3 (e.g., the DMRS may be mapped every 4 subcarriers).

In addition, in FIG. 2, the DMRS sequences are mapped with an identical density and at an identical frequency position between a plurality of symbols (2 symbols in this case) for the NR-PBCH in the SS block.

An aggregation of one or a plurality of SS blocks composed as described above may be referred to as an SS burst. The SS burst may include SS blocks of contiguous frequency and/or time resources or may include SS blocks of non-contiguous frequency and/or time resources. The SS burst is preferably transmitted per given periodicity (that may be referred to as an SS burst periodicity). Alternatively, the SS burst may not be transmitted per periodicity (or may be transmitted aperiodically).

Furthermore, one or a plurality of SS bursts may be referred to as an SS burst set (SS burst series). For example, a radio base station (also referred to as, for example, a Base Station (BS), a Transmission/Reception Point (TRP), an eNodeB (eNB) or a gNB) and/or the user terminal may beam-sweep and transmit the NR-PSS, the NR-SSS and the NR-PBCH (also referred to as, for example, the NR-PSS/SSS/PBCH) by using one or more SS bursts included in one SS burst set. In addition, the SS burst set is transmitted periodically. The UE may control reception processing assuming that the SS burst set is transmitted periodically (at an SS burst set periodicity).

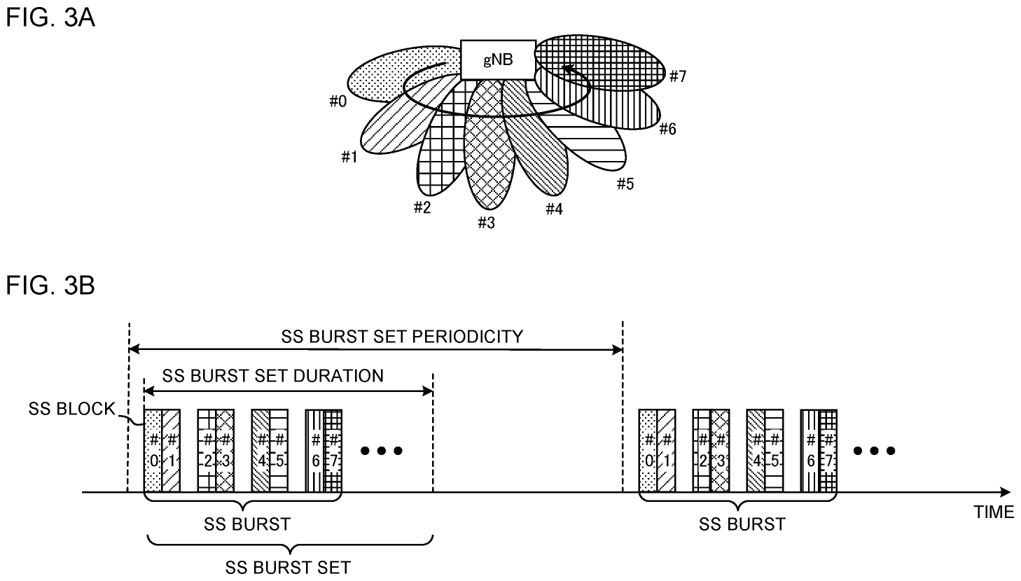

FIG. 3 is a diagram illustrating one example of an SS burst set. FIG. 3A illustrates one example of beam sweeping. As illustrated in FIGS. 3A and 3B, a radio base station (gNB) may temporarily differ (beam-sweep) beam directionality, and transmit different SS blocks by using different beams. In addition, FIGS. 3A and 3B illustrate the example where multiple beams are used. However, it is also possible to transmit an SS block by using a single beam.

As illustrated in FIG. 3B, the SS burst includes one or more SS blocks, and an SS burst set includes one or more SS bursts. For example, the SS burst includes 8 SS blocks #0 to #7 in FIG. 3B, yet is not limited to this. The SS blocks #0 to #7 may be transmitted by respectively different beams #0 to #7 (FIG. 3A).

As illustrated in FIG. 3B, the SS burst set including the SS blocks #0 to #7 may be transmitted without passing a given duration (e.g., 5 ms or less that is also referred to as, for example, an SS burst set duration). Furthermore, the SS burst set may be repeated at a given periodicity (e.g., 5, 10, 20, 40, 80 or 160 ms that is also referred to as, for example, an SS burst set periodicity).

In addition, in FIG. 3B, there is a given time interval respectively between the SS blocks #1 and #2, #3 and #4, and #5 and #6, yet this time interval may not be provided therebetween and may be provided between other SS blocks (e.g., between SS blocks #2 and #3 or #5 and #6). At the time interval, for example, a DL control channel (also referred to as, for example, a PDCCH: Physical Downlink Control Channel, an NR-PDCCH or Downlink Control Information (DCI)) may be transmitted, and/or a UL control channel (PUCCH: Physical Uplink Control Channel) may be transmitted from the user terminal. When, for example, each SS block includes 4 symbols, a slot of 14 symbols may include an NR-PDCCH of 2 symbols, two SS blocks, an NR-PUCCH corresponding to 2 symbols, and a guard time.

In FIGS. 3A and 3B, the user terminal is assumed to derive a time index for timing identification based on identification information of the SS block (SS block identification information) to be transmitted by a certain beam. As described above, the time index may be at least one of, for example, a radio frame number, a slot number, a symbol number, an SFN in a TTI of the NR-PBCH, and a number indicating a first half or a second half in the radio frame.

In this regard, the SS block identification information may be each index (SS block index) for uniquely identifying each SS block in the SS burst set. In this case, the user terminal may derive a time index based on the SS block index.

Alternatively, the SS block identification information may be a combination of the SS block index for uniquely identifying each SS block in the SS burst, and an index (SS burst index) for uniquely identifying each SS burst in the SS burst set. In this case, the user terminal may derive the time index based on the SS block index and the SS burst index. In addition, the SS burst index is common between the SS blocks in the same SS burst.

This SS block identification information is associated with each NR-PSS/SSS/PBCH. For example, the user terminal may assume that the NR-PSS/SSS/PBCH associated with the same SS block index are transmitted from an identical antenna port (by, for example, being applied an identical beam or identical precoding). Furthermore, the SS block index may be associated with at least one of sequences of the NR-PSS/SSS/PBCH and a mapping position (time and/or frequency resources).

Furthermore, it has been studied to use as a method for indicating SS block identification information, for example, (1) explicit indication that uses an NR-PBCH, (2) implicit indication that uses the NR-PBCH, (3) implicit indication that uses a DMRS of the NR-PBCH or a combination of these indications. Hereinafter, a case where an SS block index is indicated as the SS block identification information will be described as one example.

This indication method has a risk that, according to (1) the explicit indication, as the number of bits of the NR-PBCH increases, an NR-PBCH payload increases and therefore performance of the NR-PBCH lowers. According to (2) and (3) the explicit indications, it is necessary to take into account an information amount (the number of bits) of the SS block identification information and/or a sequence used for the DMRS described below.

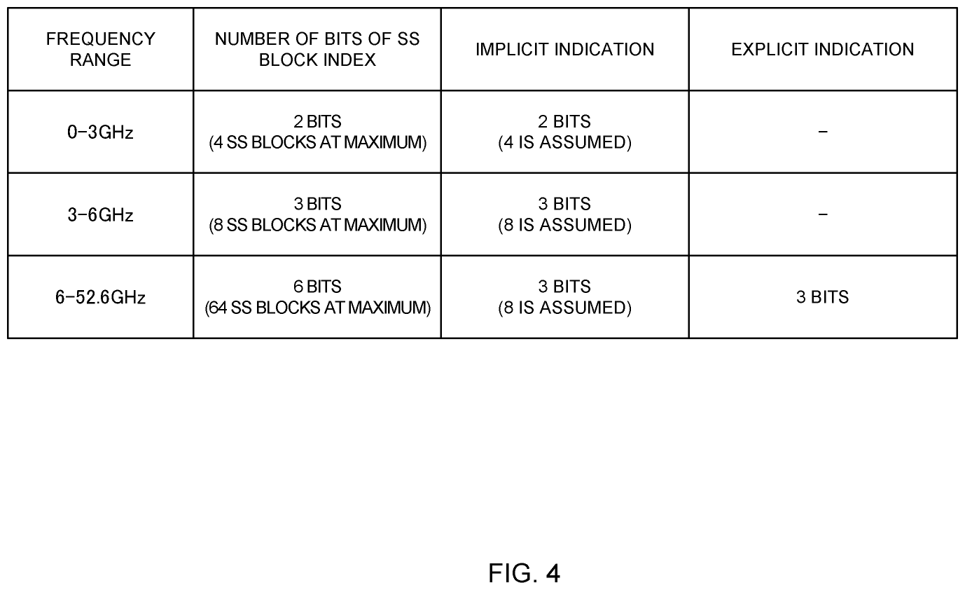

First, the number of SS blocks (the information amount of the SS block identification information) matching a frequency range will be described with reference to FIG. 4. The maximum number of SS blocks in an SS burst set is assumed to differ per frequency range (also referred to as, for example, a frequency band or a frequency band). For example, the SS burst set may include 4 SS blocks at maximum in a first frequency range (e.g., 0 to 3 GHz), the SS burst set may include 8 SS blocks at maximum in a second frequency range (e.g., 3 to 6 GHz), and the SS burst set may include 64 SS blocks at maximum in a third frequency range (e.g., 6 to 52.6 GHz).

Thus, when the maximum number of SS blocks in the SS burst set differs per frequency range, an SS block index may be indicated according to a method matching the frequency range (or the maximum number). In, for example, FIG. 4, when the frequency range is smaller than 6 GHz, the SS block index may be implicitly indicated by using a DMRS of an NR-PBCH. On the other hand, in FIG. 4, when the frequency range is 6 to 52.6 GHz, 3 bits of the SS block index are implicitly indicated by using the DMRS of the NR-PBCH, and remaining 3 bits may be explicitly indicated by using a payload of the NR-PBCH.

Next, a sequence used for (allocated to) a DMRS will be described. It has been studied to (1) apply a gold sequence, (b) generate a sequence from cell identification information (cell ID) and a time index (time identification), or (c) apply a sequence that differs between a plurality of NR-PBCH symbols to a DMRS sequence.

According to (a) application of the gold sequence, when, for example, the DMRS is allocated to 72 Resource Blocks (RBs) on one NR-PBCH, approximately 5184 72-length gold sequences can be generated. According to (b) generation of the sequence, 1008 cell IDs are used. Furthermore, as described above, the time index is derived from SS block identification information.

According to (c) application of the sequence that differs per symbol, a long sequence may be divided and arranged on a plurality of NR-PBCH symbols (e.g., the first half is arranged on the first symbol, and the second half is arranged on the second symbol). A first position at which the sequence is mapped may be shifted (cyclic shift) (different mapping). Furthermore, a sequence to be generated may be differed (different initialization).

When the information amount of the SS block identification information (FIG. 4) and/or the sequences ((a) to (c)) used for the DMRS are taken into account according to (2) and (3) the above implicit indication, the following points are considered.

First, a cross-correlation property between sequences is preferably low to perform accurate channel estimation and highly reliable detection of the SS block identification information (SS block index) between different cells (cell IDs).

Furthermore, how to implicitly indicate the SS block identification information amount (2 bits or 3 bits) by a DMRS arranged on the NR-PBCH is considered. As described above, it is possible to generate the approximately 5184 72-length gold sequences. However, when there are the 1008 cell IDs and the SS block identification information amount is 3 bits, 8064 types of sequences are necessary to express all combinations, and only the above number of gold sequences is insufficient.

Hence, there is also a problem as to how to apply patterns (the number of sequences) of the DMRS sequence and, in addition, RE mapping/arrangement per cell ID to implicit indication.

As described above, various methods have been studied as the SS block identification information indication method. However, it is desired to indicate the SS block identification information to the user terminal by a method having higher reliability and/or lower complexity.

Hence, the inventors of this application have focused on that an SS block includes a plurality of symbols for an NR-PBCH, and conceived generating a DMRS sequence of the NR-PBCH to be allocated to a plurality of these symbols based on a cell ID and different part of SS block identification information. In other words, the cell ID and part of the SS block identification information are specified based on the DMRS sequence allocated to one symbol of a plurality of symbols, and the above cell ID and the other part of the SS block identification information are specified based on DMRS sequences allocated to other symbols. Consequently, the DMRS sequences to be allocated to a plurality of symbols are different DMRS sequences.

According to this configuration, even when the 1008 cell IDs are used, DMRS sequences of a low cross-correlation property can be used between neighboring cells to design DMRS sequences. Consequently, it is possible to perform accurate channel estimation and highly reliable detection of the SS block identification information.

Furthermore, it is possible to generate a different DMRS sequence for specifying 2-bit or 3-bit SS block identification information by using a plurality of symbols (e.g., two symbols) included in an SS block.

One embodiment of the present invention will be described in detail with reference to the drawings below. In the following description, any configuration exemplified in FIGS. 1A to 1C may be applied or an unillustrated configuration (e.g., 5-symbol configuration) may be applied to the SS block. Only a plurality of symbols for an NR-PBCH in an SS block will be exemplified. However, the SS block naturally includes symbols for an NR-PSS/SSS.

Furthermore, a case where DMRSs are mapped at frequency positions of an equal interval (e.g., one or more subcarriers) in each symbol for the NR-PBCH will be described below. However, as described above, the frequency positions and/or the density at which the DMRSs are mapped are not limited to those exemplified below.

Furthermore, a case where an SS block index is indicated as SS block identification information will be described as one example below. However, when an SS block index and an SS burst index are indicated as the SS block identification information, the following “SS block index” can be replaced with “an SS block index and an SS burst index” and applied.

(First Aspect) According to the first aspect, a DMRS sequence of a first symbol is generated based on a cell ID (Physical Cell ID (PCI)) and part of an SS block index, and a DMRS sequence of a second symbol is generated based on the cell ID and other part (or remaining part) of the SS block index.

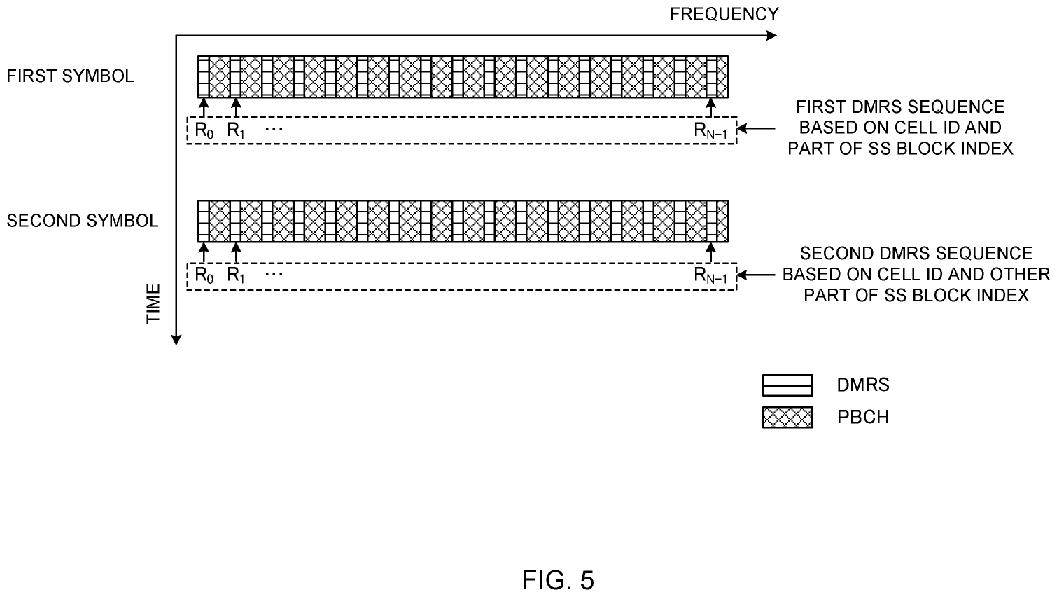

FIG. 5 is a diagram illustrating one example of indication of the SS block index according to the first aspect. As illustrated in FIG. 5, a radio base station may generate a first DMRS sequence of the first symbol for an NR-PBCH based on a cell ID and part of an SS block index. A user terminal specifies the cell ID by detecting an NR-PSS/SSS in an initial access procedure.

Furthermore, the above part of the SS block index may be information for identifying a time index (e.g., at least one of a radio frame number, a slot number, a symbol number, an SFN in a TTI of the NR-PBCH, and a number indicating a first half or a second half in the radio frame).

As described above, the time index is derived based on the SS block index, and therefore it is also assumed that the user terminal cannot specify the time index at a point of time at which the first DMRS sequence is determined. Hence, when the first DMRS sequence is based on the cell ID and the time index, the user terminal may specify the first DMRS sequence based on the cell ID specified by detection of the NR-PSS/SSS, and blind-detection that uses each candidate of the time index.

On the other hand, the radio base station may generate a second DMRS sequence of a second symbol for the NR-PBCH based on the cell ID and the other part (or remaining part) of the SS block index. The other part (or remaining part) of the SS block index may be information for identifying the time index (e.g., at least one of a radio frame, a slot number, a symbol number, an SFN in the TTI of the NR-PBCH, and a number indicating the first half or the second half in the radio frame).

In addition, a maximum number of SS blocks in an SS burst set is defined in advance per frequency range (see FIG. 4). Hence, the cell ID may be associated with one or more SS block index candidates per frequency range. In this case, the user terminal may specify the first DMRS and second DMRS sequences by blind-detection that uses each candidate of the SS block index defined per frequency range.

In FIG. 5, the user terminal may specify the SS block index based on the first DMRS sequence and the second DMRS sequence specified as described above.

In addition, when the SS block index is 2 bits, the first DMRS sequence may be generated based on the cell ID and 1 bit of the above 2 bits. In this case, the second DMRS sequence may be generated based on the cell ID and the remaining 1 bit.

When the SS block index is 3 bits, the first DMRS sequence may be generated based on 1 bit or 2 bits of the above 3 bits. In this case, the second DMRS sequence may be generated based on the cell ID, the remaining 2 bits and the remaining 1 bit.

As the cell IDs used to generate the first DMRS sequence and the second DMRS sequence, cell IDs different from cell IDs specified by detecting the NR-PSS/SSS in the initial access procedure may be used. Furthermore, the cell ID of the first DMRS sequence and the cell ID of the second DMRS sequence may be different.

For example, gold sequences may be applied to the above first DMRS sequence and second DMRS sequence. More specifically, a 72-length gold sequence generated by a 7-bit linear register (LFSR: Linear Feedback Shift Register) may be applied, and BPSK may be used for modulation. Alternatively, a 144-length gold sequence generated by an 8-bit linear register may be applied, and QPSK may be used for modulation. Such specific application of a gold sequence applies likewise to examples described below and other aspects, too.

In this first aspect, the first DMRS sequence and the second DMRS sequence are different sequences. In this regard, the “different sequences” may include that the generated sequences are different (different initialization) and, in addition, a long sequence is divided into the first DMRS sequence and the second DMRS sequence. Furthermore, a first position at which the sequence is mapped may be shifted (cyclic shift) (different mapping).

As described above, according to the first aspect, a plurality of entire symbols (the first DMRS sequence and the second DMRS sequence) indicate an SS block index, so that the user terminal can specify the SS block index with high reliability and/or low complexity. Furthermore, it is possible to use DMRS sequences of a low cross-correlation property between neighboring cells. Consequently, it is possible to perform accurate channel estimation and highly reliable detection of SS block identification information.

### Example 1

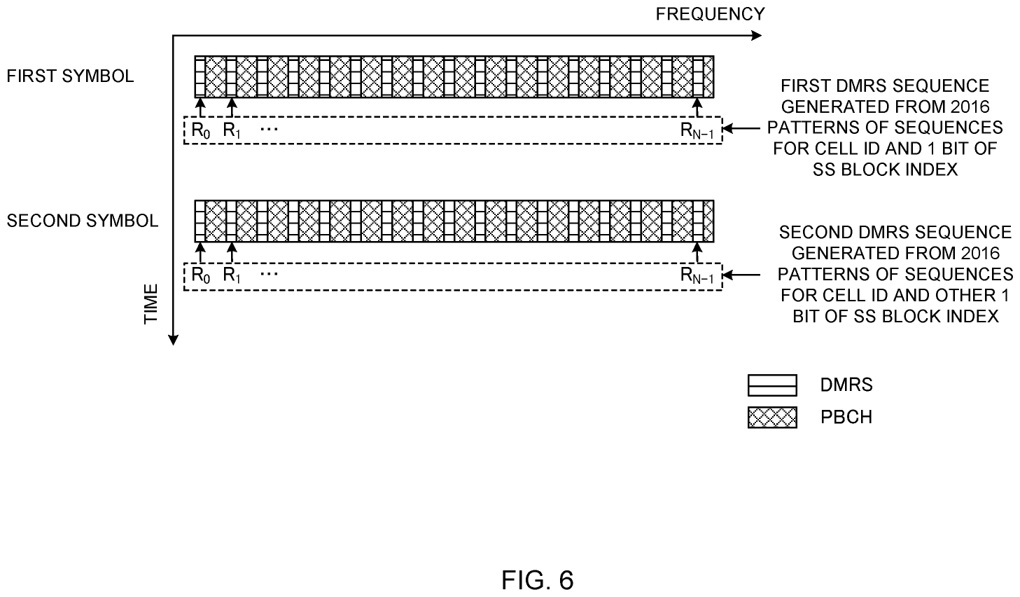

Next, a specific example (example 1) of the first aspect will be described with reference to FIG. 6. FIG. 6 is a diagram illustrating one example of indication of a 2-bit SS block index according to the first aspect.

As illustrated in FIG. 6, for the first DMRS sequence of the first symbol for the NR-PBCH, a sequence generated (computed, configured, associated or selected) from 2016 patterns of sequences for a cell ID and 1 bit of an SS block index is used. For the second DMRS sequence of the second symbol for the NR-PBCH, a sequence generated (computed, configured, associated or selected) from 2016 patterns of sequences for the cell ID and other 1 bit of the SS block index is used.

The 2016 patterns of the sequences for the first DMRS sequence, and the 2016 patterns of the sequences for the second DMRS sequence may entirely differ or partially overlap (common). In this regard, the generated DMRS sequences differ between the first symbol and the second symbol.

According to the example 1, a plurality of entire symbols (the first DMRS sequence and the second DMRS sequence) indicate a 2-bit SS block index, so that the user terminal can specify the SS block index with high reliability and/or low complexity. For example, the example 1 is applicable to implicit indication of the frequency range of 0 to 3 GHz in FIG. 4.

Furthermore, the first and second DMRS sequences can be each generated (computed, configured, associated or selected) from the 2016 patterns of sequences, so that it is possible to use DMRS sequences of a low cross-correlation property between neighboring cells. Consequently, it is possible to perform accurate channel estimation and highly reliable detection of SS block identification information.

### Example 2

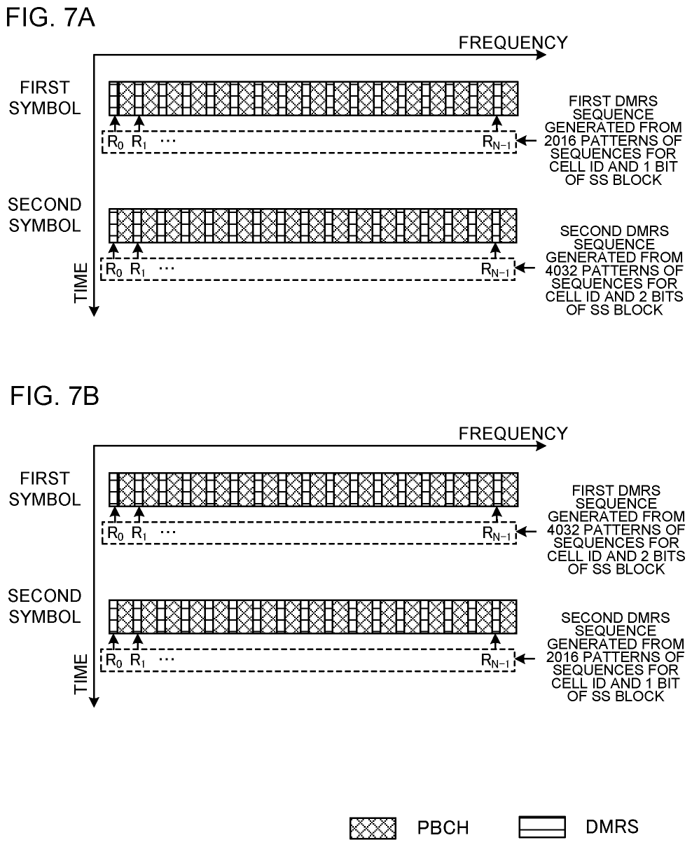

Next, a specific example (example 2) of the first aspect will be described with reference to FIGS. 7A and 7B. FIGS. 7A and 7B illustrate examples where a 3-bit SS block index is indicated.

FIG. 7A is a diagram illustrating one example of indication of an SS block index according to the first aspect. As illustrated in FIG. 7A, for the first DMRS sequence of the first symbol for the NR-PBCH, a sequence generated (computed, configured, associated or selected) from the 2016 patterns of sequences for the cell ID and 1 bit of the SS block index is used. For the second DMRS sequence of the second symbol for the NR-PBCH, a sequence generated (computed, configured, associated or selected) from the 4032 patterns of sequences for the cell ID and other 2 bits of the SS block index is used.

The 2016 patterns of the sequences for the first DMRS sequence and the 4032 patterns of the sequences for the second DMRS sequence may entirely differ or partially overlap (common). In this regard, the DMRS sequences to be generated are different between the first symbol and the second symbol.

An example illustrated in FIG. 7B is an example where the DMRS sequences of the first symbol and the second symbol in FIG. 7A are switched, and therefore detailed description will be omitted.

According to the example 2, a plurality of entire symbols (the first DMRS sequence and the second DMRS sequence) indicate a 3-bit SS block index, so that the user terminal can specify the SS block index with high reliability and/or low complexity. For example, the example 2 is applicable to implicit indication of a frequency range equal to or more than 3 GHz in FIG. 4.

Furthermore, one of the first and second DMRS sequences can be each generated (computed, configured, associated or selected) from the 2016 patterns of the sequences, and the other one can be generated from the 4032 patterns of the sequences, so that it is possible to use DMRS sequences of a low cross-correlation property between neighboring cells. Consequently, it is possible to perform accurate channel estimation and highly reliable detection of SS block identification information.

(Second Aspect)

Next, the second aspect will be described. According to the second aspect, a DMRS sequence of a first symbol is generated based on a cell ID and part of an SS block index, and a DMRS sequence of a second symbol is generated based on the cell ID and other part of the SS block index. Furthermore, subcarrier shift is applied to the DMRS sequences of the first and second symbols based on remaining part of the SS block index.

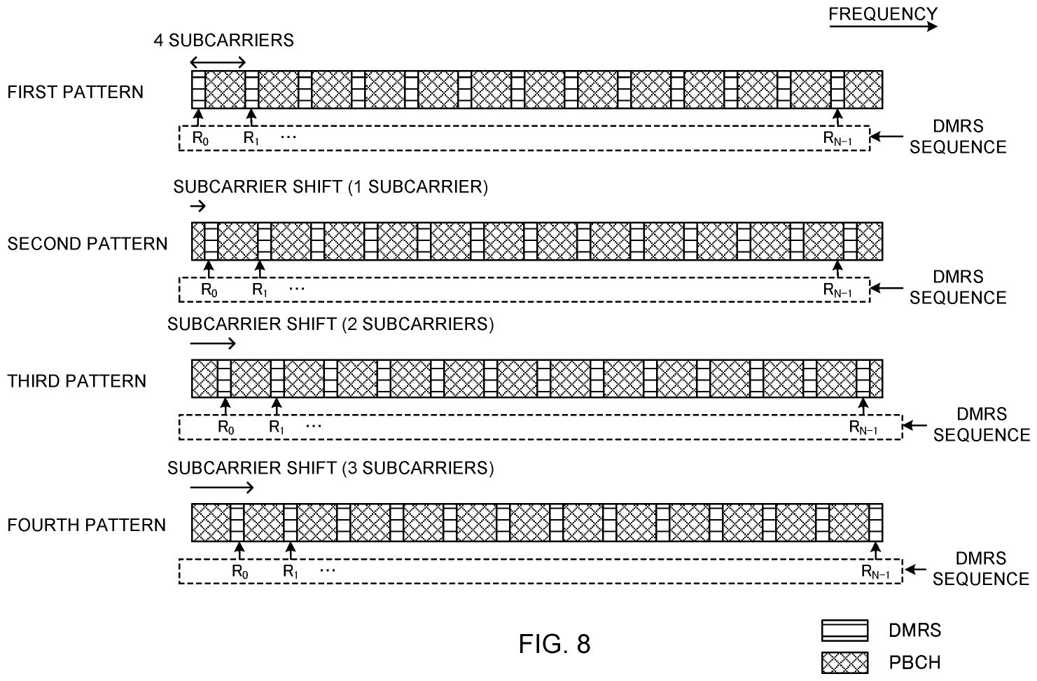

Hereinafter, the subcarrier shift will be described with reference to FIG. 8. DMRSs are arranged every 4 subcarriers in a frequency domain direction in 1 symbol. Hence, four arrangement patterns are formed by shifting a subcarrier on which the DMRS is arranged 1 subcarrier by 1 subcarrier.

A first pattern in FIG. 8 indicates a case where subcarrier shift is not performed (0 subcarrier shift). A second pattern indicates a case where a subcarrier is shifted by 1 subcarrier (1 subcarrier shift). Similarly, a third pattern and a fourth pattern respectively indicate cases where subcarriers are shifted by 2 subcarriers and 3 subcarriers (2 subcarrier shift and 3 subcarrier shift).

In this regard, by using two patterns of the first to fourth patterns, it is possible to indicate, for example, 1 bit of the SS block index. In addition, an NR-PBCH may include 288 REs.

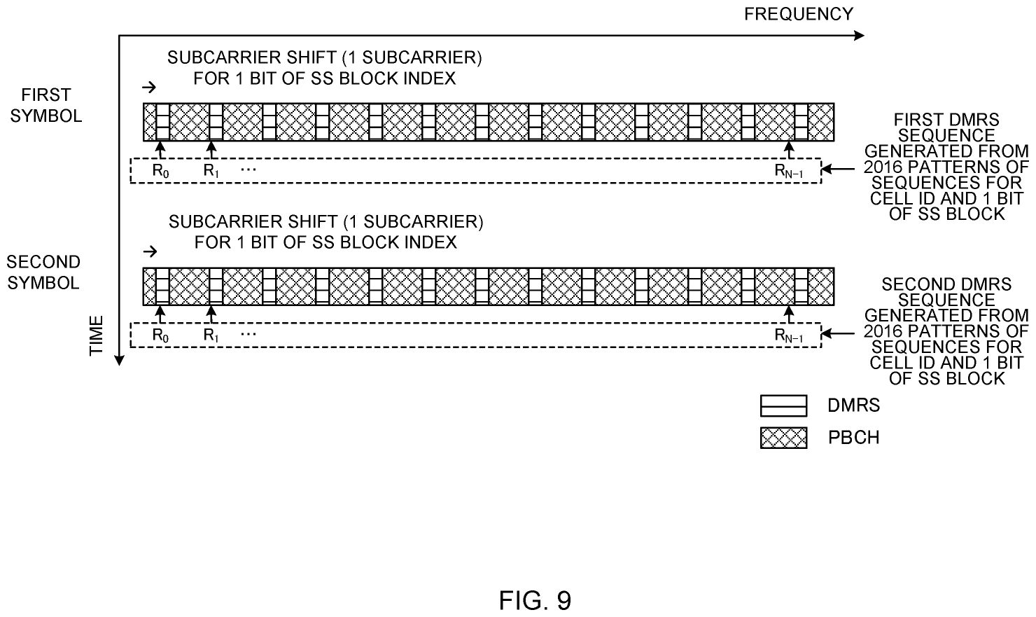

FIG. 9 illustrates an example where a 3-bit SS block index is indicated according to the second aspect. As illustrated in FIG. 9, for the first DMRS sequence of the first symbol for the NR-PBCH, a sequence generated (computed, configured, associated or selected) from 2016 patterns of sequences for the cell ID and 1 bit of the SS block index is used. For the second DMRS sequence of the second symbol for the NR-PBCH, a sequence generated (computed, configured, associated or selected) from 2016 patterns of sequences for the cell ID and other 1 bit of the SS block index is used.

Furthermore, subcarrier shift is applied to the DMRS sequences of the first and second symbols based on the remaining 1 bit of the SS block index. In FIG. 9, a pattern 2 (FIG. 8) for shifting a subcarrier by 1 subcarrier is applied.

According to this second aspect, it is possible to indicate more information in addition to indices identified based on the DMRS sequences. Furthermore, a plurality of entire symbols (the first DMRS sequence and the second DMRS sequence) indicate a 3-bit SS block index, so that a user terminal can specify the SS block index with high reliability and/or low complexity. For example, the second aspect is applicable to implicit indication of a frequency range equal to or more than 3 GHz in FIG. 4.

Furthermore, the first and second DMRS sequences can be generated (computed, configured, associated or selected) from the 2016 patterns of sequences, so that it is possible to use DMRS sequences of a low cross-correlation property between neighboring cells. Consequently, it is possible to perform accurate channel estimation and highly reliable detection of SS block identification information.

In addition, the 2016 patterns of the sequences for the first DMRS sequence and the 2016 patterns of the sequences for the second DMRS sequence may entirely differ or partially overlap (common). In this regard, the DMRS sequences to be generated are different between the first symbol and the second symbol.

Furthermore, the examples where the DMRSs are arranged every 4 subcarriers in the frequency domain direction have been described with reference to FIGS. 8 and 9. However, an interval at which the DMRSs are arranged is not limited to this.

This second aspect can be read as an aspect where subcarrier shift is applied to an arrangement of a DMRS in the indication example of the example 1 (FIG. 6) of the first aspect. Hence, similar to the first aspect, the above part of the SS block index may be information for identifying a time index (e.g., at least one of a radio frame number, a slot number, a symbol number, an SFN in a TTI of the NR-PBCH, and a number indicating a first half or a second half in the radio frame).

In addition, that a DMRS sequence may be specified by blind detection that uses each candidate of the SS block index or the time index is also considered in a similar way to the above first aspect.

Furthermore, as the cell IDs used to generate the first DMRS sequence and the second DMRS sequence, cell IDs different from cell IDs specified by detecting an NR-PSS/SSS in an initial access procedure may be used. Furthermore, the cell ID of the first DMRS sequence and a cell ID of the second DMRS sequence may be different.

For example, gold sequences may be applied to the above first DMRS sequence and second DMRS sequence.

Furthermore, according to this second aspect, the first DMRS sequence and the second DMRS sequence are different sequences. In this regard, the “different sequences” may include that the generated sequences are different (different initialization) and, in addition, a long sequence is divided into the first DMRS sequence and the second DMRS sequence. Furthermore, a first position at which the sequence is mapped may be shifted (cyclic shift) (different mapping).

(Third Aspect)

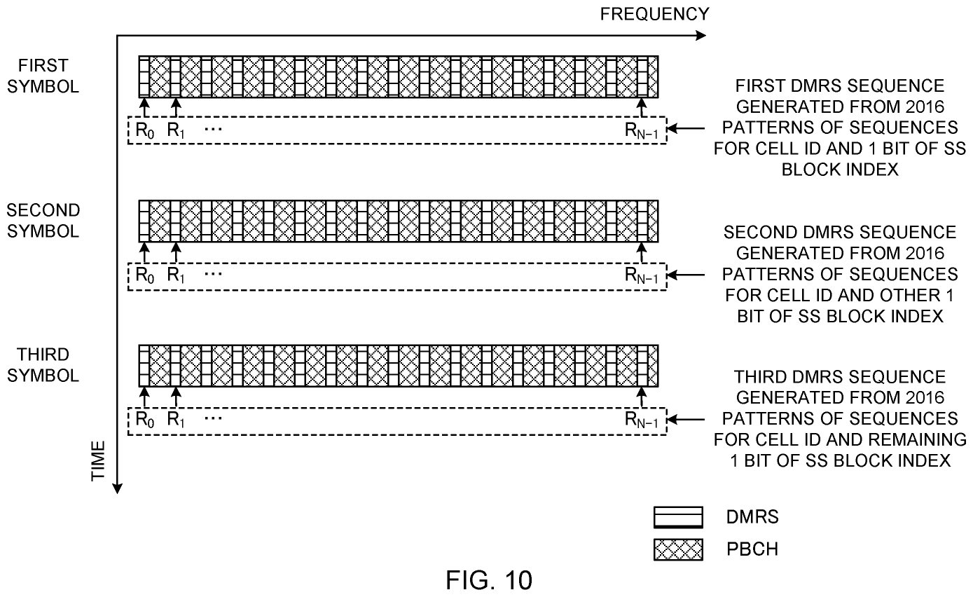

Next, the third aspect will be described. FIG. 10 is a diagram illustrating one example of indication of an SS block index according to the third aspect. As illustrated in FIG. 10, an SS block index may include 5 symbols in total including 3 symbols for an NR-PBCH, 1 symbol for an unillustrated NR-PSS and 1 symbol for an NR-SSS. In addition, the 3 symbols for the NR-PBCH in FIG. 10 may be contiguous or at least 2 symbols may not be contiguous.

According to the third aspect, a DMRS sequence of a first symbol is generated based on a cell ID and part (1 bit) of an SS block index. A DMRS sequence of a second symbol is generated based on the cell ID and other part (other 1 bit) of the SS block index. Furthermore, a DMRS sequence of a third symbol is generated based on the cell ID and remaining part (remaining 1 bit) of the SS block index.

For the first to third DMRS sequences, sequences generated (computed, configured, associated or selected) from 2016 patterns of sequences for the cell ID and each 1 bit of the SS block index are used.

According to this third aspect, a plurality of entire symbols (first to third DMRS sequences) indicate a 3-bit SS block index, so that a user terminal can specify the SS block with high reliability and/or low complexity. For example, the third aspect is applicable to implicit indication of a frequency range equal to or more than 3 GHz in FIG. 4.

Furthermore, the first to third DMRS sequences can be generated (computed, configured, associated or selected) from the 2016 patterns of sequences, so that it is possible to use DMRS sequences of a low cross-correlation between neighboring cells. Consequently, it is possible to perform accurate channel estimation and highly reliable detection of the SS block identification information.

In addition, the 2016 patterns of the sequences for the first to third DMRS sequences may entirely differ or partially overlap (common) between the first and third DMRSs. In this regard, the DMRS sequences to be generated are different between the first and third symbols.

This third aspect can be read as that the indication method in the example 1 (FIG. 6) of the first aspect is applied to three symbols. Therefore, similar to the first aspect, the above part of the SS block index may be information for identifying a time index (e.g., at least one of a radio frame number, a slot number, a symbol number, an SFN in a TTI of the NR-PBCH, and a number indicating a first half or a second half in the radio frame).

In addition, that a DMRS sequence may be specified by blind detection that uses each candidate of the SS block index or the time index is also considered in a similar way to the above first aspect.

Furthermore, as the cell IDs used to generate the first to third DMRS sequences, cell IDs different from cell IDs specified by detecting the NR-PSS/SSS in the initial access procedure may be used. Furthermore, the cell IDs of the first to third DMRS sequence may be different.

For example, gold sequences may be applied to the above first to third DMRS sequences.

Furthermore, in this third aspect, the first to third DMRS sequences are respectively different sequences. In this regard, the “different sequences” may include that the generated sequences are different (different initialization) and, in addition, a long sequence is divided into the first DMRS sequence and the second DMRS sequence. Furthermore, a first position at which the sequence is mapped may be shifted (cyclic shift) (different mapping).

(Fourth Aspect)

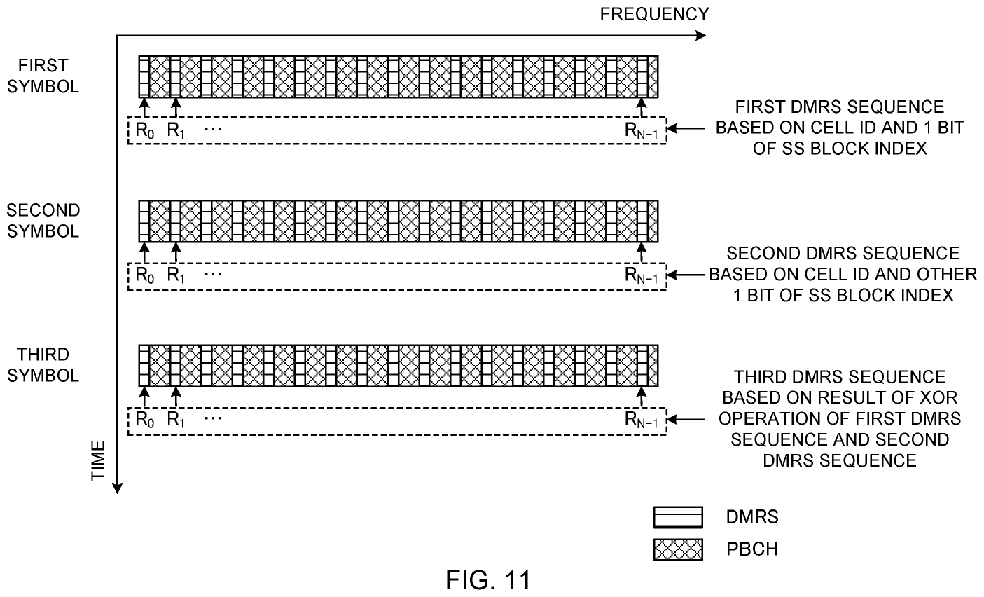

Next, the fourth aspect will be described. FIG. 11 is a diagram illustrating one example of indication of an SS block index according to the fourth aspect. As illustrated in FIG. 11, an SS block index may include 5 symbols in total including 3 symbols for an NR-PBCH, 1 symbol for an unillustrated NR-PSS and 1 symbol for an NR-SSS. In addition, the 3 symbols for the NR-PBCH in FIG. 11 may be contiguous or at least 2 symbols may not be contiguous.

According to the fourth aspect, a DMRS sequence of a first symbol is generated based on a cell ID and part (1 bit) of an SS block index. A DMRS sequence of a second symbol is generated based on the cell ID and remaining part (remaining 1 bit) of the SS block index. For the first and second DMRS sequences, sequences generated (computed, configured, associated or selected) from 2016 patterns of sequences for the cell ID and each 1 bit of the SS block index are used.

In this regard, a sequence based on a result of an XOR operation of the first DMRS sequence and the second DMRS sequence is applied to a DMRS sequence of a third symbol. Consequently, it is possible to use the third DMRS sequence of the third symbol to verify whether or not the first and second DMRS sequences have been correctly received. In other words, a user terminal can use the third DMRS sequence to be allocated to the third symbol to detect a reception error of the first DMRS sequence and the second DMRS sequence.

According to this fourth aspect, the first and second DMRS sequences indicate a 2-bit SS block index, so that the user terminal can specify the SS block with high reliability and/or low complexity. For example, the fourth aspect is applicable to implicit indication of a frequency range of 0 to 3 GHz in FIG. 4.

Furthermore, the first and DMRS sequences can be generated (computed, configured, associated or selected) from the 2016 patterns of sequences, so that it is possible to use DMRS sequences of a low cross-correlation between neighboring cells. Consequently, it is possible to perform accurate channel estimation and highly reliable detection of the SS block identification information.

Furthermore, according to the fourth aspect, it is possible to check a reception error of DMRS sequences arranged on other symbols by using a DMRS sequence arranged on a given symbol. Consequently, it is possible to perform highly reliable detection of the SS block identification information.

In addition, the 2016 patterns of the sequences for the first DMRS sequence and the 2016 patterns of the sequences for the second DMRS sequence may entirely differ or partially overlap (common). In this regard, the DMRS sequences to be generated are different between the first symbol and the second symbol.

Furthermore, similar to the first aspect, according to this fourth aspect, the above part (1 bit) of the SS block index may be information for identifying a time index (e.g., at least one of a radio frame number, a slot number, a symbol number, an SFN in a TTI of the NR-PBCH, and a number indicating a first half or a second half in the radio frame).

In addition, a DMRS sequence may be specified by blind detection that uses each candidate of the SS block index or the time index.

Furthermore, as the cell IDs used to generate the first and second DMRS sequences, cell IDs different from cell IDs specified by detecting the NR-PSS/SSS in the initial access procedure may be used. Furthermore, the cell IDs of the first and second DMRS sequences may be different.

For example, gold sequences may be applied to the above first to third DMRS sequence.

Furthermore, in this fourth aspect, the first and second DMRS sequences are respectively different sequences. In this regard, the “different sequences” may include that the generated sequences are different (different initialization) and, in addition, a long sequence is divided into the first DMRS sequence and the second DMRS sequence. Furthermore, a first position at which the sequence is mapped may be shifted (cyclic shift) (different mapping).

Furthermore, the fourth aspect has described the case where the SS block index is 2 bits, yet is not limited to this, and is applicable to a case, too, where the SS block index is 3 bits. For example, the example 2 (FIGS. 7A and 7B) in the first aspect may be applied to the DMRS sequences of the first and second symbols. Alternatively, the second aspect (FIG. 9) that uses subcarrier shift may be applied to the DMRS sequences of the first and second symbols.

(Radio Communication System)

The configuration of the radio communication system according to the present embodiment will be described below. This radio communication system uses one or a combination of each of the above aspects of the present invention to perform communication.

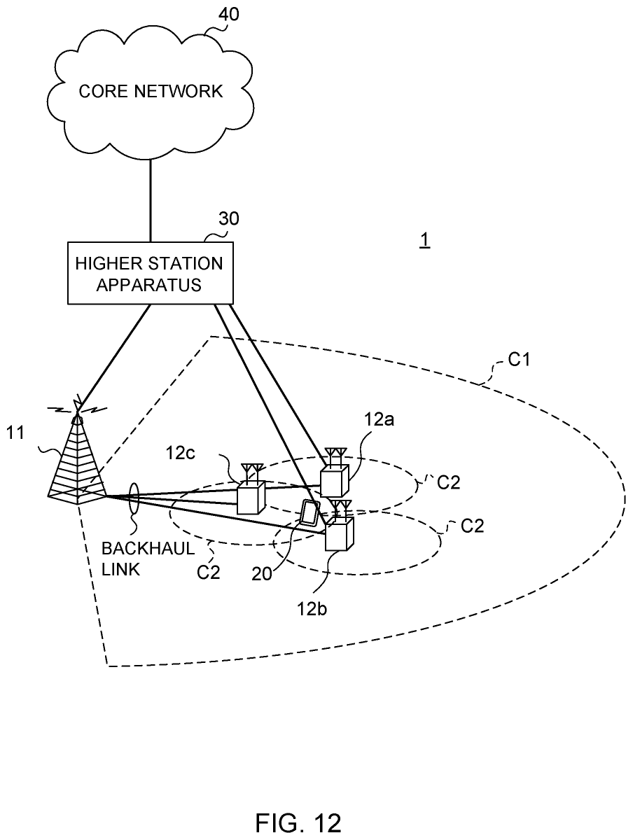

FIG. 12 is a diagram illustrating one example of a schematic configuration of the radio communication system according to the present embodiment. A radio communication system 1 can apply Carrier Aggregation (CA) and/or Dual Connectivity (DC) that aggregate a plurality of base frequency blocks (component carriers) whose 1 unit is a system bandwidth (e.g., 20 MHz) of the LTE system.

In this regard, the radio communication system 1 may be referred to as Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), Future Radio Access (FRA), the New Radio Access Technology (New-RAT) or NR, or a system that realizes these techniques.

The radio communication system 1 includes a radio base station 11 that forms a macro cell C1 of a relatively wide coverage, and radio base stations 12 (12a to 12c) that are located in the macro cell C1 and form small cells C2 narrower than the macro cell C1. Furthermore, a user terminal 20 is located in the macro cell C1 and each small cell C2.

The user terminal 20 can connect with both of the radio base station 11 and the radio base stations 12. The user terminal 20 is assumed to concurrently use the macro cell C1 and the small cells C2 by CA or DC. Furthermore, the user terminal 20 can apply CA or DC by using a plurality of cells (CCs) (e.g., five CCs or less or six CCs or more). For example, according to DC, an MeNB (MCG) adopts LTE cells, and an SeNB adopts NR/5G-cells to perform communication.

The user terminal 20 and the radio base station 11 can communicate by using a carrier (referred to as a Legacy carrier) of a narrow bandwidth in a relatively low frequency band (e.g., 2 GHz). On the other hand, the user terminal 20 and each radio base station 12 may use a carrier of a wide bandwidth in a relatively high frequency band (e.g., 3.5 GHz or 5 GHz) or may use the same carrier as that used between the user terminal 20 and the radio base station 11. In this regard, a configuration of the frequency band used by each radio base station is not limited to this.

The radio base station 11 and each radio base station 12 (or the two radio base stations 12) can be configured to be connected by way of wired connection (e.g., optical fibers compliant with a Common Public Radio Interface (CPRI) or an X2 interface) or radio connection.

The radio base station 11 and each radio base station 12 are each connected with a higher station apparatus 30 and connected with a core network 40 via the higher station apparatus 30. In this regard, the higher station apparatus 30 includes, for example, an access gateway apparatus, a Radio Network Controller (RNC) and a Mobility Management Entity (MME), yet is not limited to these. Furthermore, each radio base station 12 may be connected with the higher station apparatus 30 via the radio base station 11.

In this regard, the radio base station 11 is a radio base station that has a relatively wide coverage, and may be referred to as a macro base station, an aggregate node, an eNodeB (eNB) or a transmission/reception point. Furthermore, each radio base station 12 is a radio base station that has a local coverage, and may be referred to as a small base station, a micro base station, a pico base station, a femto base station, a Home eNodeB (HeNB), a Remote Radio Head (RRH) or a transmission/reception point. The radio base stations 11 and 12 will be collectively referred to as a radio base station 10 below when not distinguished.

Each user terminal 20 is a terminal that supports various communication schemes such as LTE and LTE-A, and may include not only a mobile communication terminal (mobile station) but also a fixed communication terminal (fixed station).

The radio communication system 1 applies Orthogonal Frequency-Division Multiple Access (OFDMA) to downlink and Single Carrier-Frequency Division Multiple Access (SC-FDMA) to uplink as radio access schemes.

OFDMA is a multicarrier transmission scheme that divides a frequency band into a plurality of narrow frequency bands (subcarriers) and maps data on each subcarrier to perform communication. SC-FDMA is a single carrier transmission scheme that divides a system bandwidth into a band including one or contiguous resource blocks per terminal and causes a plurality of terminals to use respectively different bands to reduce an inter-terminal interference. In this regard, uplink and downlink radio access schemes are not limited to a combination of these, and other radio access schemes may be used.

The radio communication system 1 uses a downlink shared channel (PDSCH: Physical Downlink Shared Channel) shared by each user terminal 20, a broadcast channel (a PBCH: Physical Broadcast Channel or an NR-PBCH) and a downlink L1/L2 control channel as downlink channels. At least one of user data, higher layer control information and System Information Blocks (SIBs) is conveyed on the PDSCH. Furthermore, Master Information Blocks (MIBs) are conveyed on the PBCH. A common control channel for indicating whether or not there is a paging channel is mapped on a downlink L1/L2 control channel (e.g., PDCCH), and data of the paging channel (PCH) is mapped on the PDSCH. A downlink reference signal, an uplink reference signal and a physical downlink synchronization signal are additionally arranged.

The downlink L1/L2 control channel includes a Physical Downlink Control Channel (PDCCH), an Enhanced Physical Downlink Control Channel (EPDCCH), a Physical Control Format Indicator Channel (PCFICH), and a Physical Hybrid-ARQ Indicator Channel (PHICH). Downlink Control Information (DCI) including scheduling information of the PDSCH and the PUSCH is conveyed on the PDCCH. The number of OFDM symbols used for the PDCCH is conveyed on the PCFICH. Transmission acknowledgement information (also referred to as, for example, retransmission control information, HARQ-ACK or ACK/NACK) of a Hybrid Automatic Repeat reQuest (HARQ) for the PUSCH is conveyed on the PHICH. The EPDCCH is subjected to frequency division multiplexing with the PDSCH (downlink shared data channel) and is used to convey DCI similar to the PDCCH.

The radio communication system 1 uses an uplink shared channel (PUSCH: Physical Uplink Shared Channel) shared by each user terminal 20, an uplink control channel (PUCCH: Physical Uplink Control Channel), and a random access channel (PRACH: Physical Random Access Channel) as uplink channels. User data and/or higher layer control information are conveyed on the PUSCH. Furthermore, downlink radio quality information (CQI: Channel Quality Indicator) and transmission acknowledgement information are conveyed on the PUCCH. A random access preamble for establishing connection with a cell is conveyed on the PRACH.

The radio communication system 1 conveys a Cell-specific Reference Signal (CRS), a Channel State Information-Reference Signal (CSI-RS), a DeModulation Reference Signal (DMRS) and a Positioning Reference Signal (PRS) as downlink reference signals. Furthermore, the radio communication system 1 conveys a Sounding Reference Signal (SRS) and a DeModulation Reference Signal (DMRS) as uplink reference signals. In this regard, the DMRS may be referred to as a user terminal-specific reference signal (UE-specific Reference Signal). Furthermore, a reference signal to be conveyed is not limited to these.

<Radio Base Station>

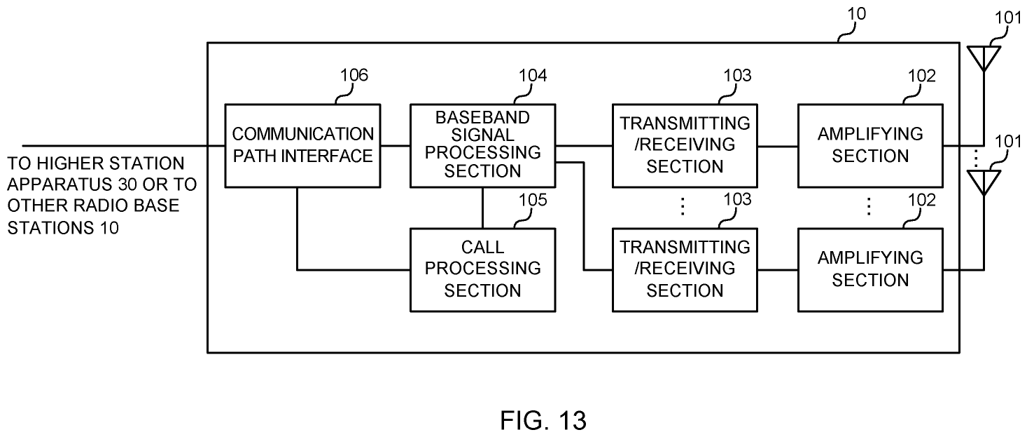

FIG. 13 is a diagram illustrating one example of an overall configuration of the radio base station according to the present embodiment. The radio base station 10 includes pluralities of transmission/reception antennas 101, amplifying sections 102 and transmission/reception sections 103, a baseband signal processing section 104, a call processing section 105 and a channel interface 106. In this regard, the radio base station 10 only needs to be configured to include one or more of each of the transmission/reception antennas 101, the amplifying sections 102 and the transmission/reception sections 103.

User data transmitted from the radio base station 10 to the user terminal 20 on downlink is input from the higher station apparatus 30 to the baseband signal processing section 104 via the channel interface 106.

The baseband signal processing section 104 performs processing of a Packet Data Convergence Protocol (PDCP) layer, segmentation and concatenation of the user data, transmission processing of a Radio Link Control (RLC) layer such as RLC retransmission control, Medium Access Control (MAC) retransmission control (e.g., HARQ transmission processing), and transmission processing such as scheduling, transmission format selection, channel coding, Inverse Fast Fourier Transform (IFFT) processing, and precoding processing on the user data, and transfers the user data to each transmission/reception section 103. Furthermore, the baseband signal processing section 104 performs transmission processing such as channel coding and/or inverse fast Fourier transform on a downlink control signal, too, and transfers the downlink control signal to each transmission/reception section 103.

Each transmission/reception section 103 converts a baseband signal precoded and output per antenna from the baseband signal processing section 104 into a radio frequency band, and transmits a radio frequency signal. The radio frequency signal subjected to frequency conversion by each transmission/reception section 103 is amplified by each amplifying section 102, and is transmitted from each transmission/reception antenna 101. The transmission/reception sections 103 can be composed of transmitters/receivers, transmission/reception circuits or transmission/reception apparatuses described based on a common knowledge in a technical field according to the present invention. In this regard, the transmission/reception sections 103 may be composed as an integrated transmission/reception section or may be composed of transmission sections and reception sections.

Meanwhile, each amplifying section 102 amplifies a radio frequency signal received by each transmission/reception antenna 101 as an uplink signal. Each transmission/reception section 103 receives the uplink signal amplified by each amplifying section 102. Each transmission/reception section 103 performs frequency conversion on the received signal into a baseband signal, and outputs the baseband signal to the baseband signal processing section 104.

The baseband signal processing section 104 performs Fast Fourier Transform (FFT) processing, Inverse Discrete Fourier Transform (IDFT) processing, error correcting decoding, reception processing of MAC retransmission control, and reception processing of an RLC layer and a PDCP layer on user data included in the input uplink signal, and transfers the user data to the higher station apparatus 30 via the channel interface 106. The call processing section 105 performs call processing such as configuration and release of a communication channel, state management of the radio base station 10, and radio resource management.

The channel interface 106 transmits and receives signals to and from the higher station apparatus 30 via a given interface. Furthermore, the channel interface 106 may transmit and receive (backhaul signaling) signals to and from the another radio base station 10 via an inter-base station interface (e.g., optical fibers compliant with the Common Public Radio Interface (CPRI) or the X2 interface).

In addition, each transmission/reception section 103 transmits a Synchronization Signal (SS) block including a plurality of synchronization signals and a plurality of broadcast channels arranged in different time-domains. Furthermore, each transmission/reception section 103 transmits a Demodulation Reference Signal (DMRS) arranged in the same time-domain as that of a broadcast channel.

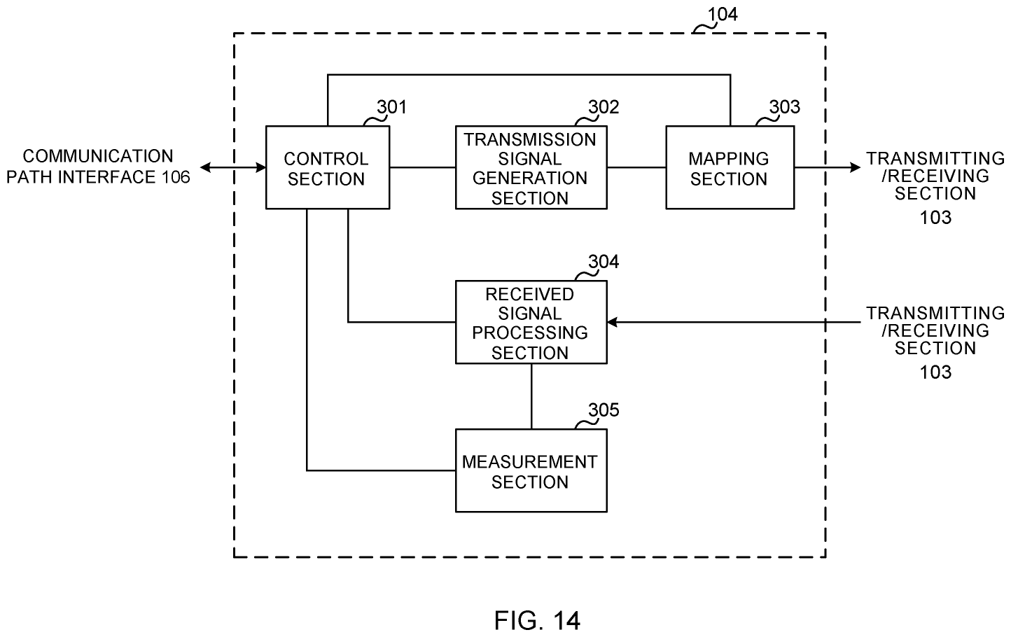

FIG. 14 is a diagram illustrating one example of a function configuration of the radio base station according to the present embodiment. In addition, this example mainly illustrates function blocks of characteristic portions according to the present embodiment, and assumes that the radio base station 10 includes other function blocks, too, that are necessary for radio communication.

The baseband signal processing section 104 includes at least a control section (scheduler) 301, a transmission signal generating section 302, a mapping section 303, a received signal processing section 304 and a measurement section 305. In addition, these components only need to be included in the radio base station 10, and part or all of the components may not be included in the baseband signal processing section 104. The baseband signal processing section 104 includes a digital beam forming function that provides digital beam forming.

The control section (scheduler) 301 controls the entire radio base station 10. The control section 301 can be composed of a controller, a control circuit or a control apparatus described based on the common knowledge in the technical field according to the present invention.

The control section 301 controls at least one of, for example, signal (including a synchronization signal, an MIB, a paging channel, and a signal matching a broadcast channel) generation of the transmission signal generating section 302 and signal allocation of the mapping section 303.

The control section 301 controls generation and transmission of the SS block including the synchronization signal and the broadcast channel (NR-PBCH). Furthermore, the control section 301 controls generation and/or mapping of a sequence of a DMRS (DMRS sequence) multiplexed on a symbol for the NR-PBCH.

More specifically, the control section 301 may control generation of the DMRS sequence to be arranged in at least part of a plurality of symbols for the NR-PBCH. For example, the control section 301 may control generation of the DMRS sequence of one symbol based on identification information of a cell (cell ID) to which the SS block is transmitted, and part (e.g., 1 bit or 2 bits) of the identification information of the SS block (SS block identification information such as an SS block index and/or an SS burst index) (first aspect). Furthermore, the control section 301 may control generation of the DMRS sequence of other symbols based on the cell ID and other part (2 bits or 1 bit) of the SS block identification information (first aspect).

In this regard, a plurality of generated DMRS sequences may be different from each other. Furthermore, the number of symbols on which the DMRS sequences are arranged may be three or more (third aspect).

Furthermore, the control section 301 may control frequency positions of the DMRS sequences to be arranged on symbols based on part different from the above part and other part of the SS block identification information (second aspect).

Furthermore, the control section 301 may perform given operation processing on a plurality of generated DMRS sequences, generate a DMRS sequence based on a result of the given operation processing, and arrange the DMRS sequence on a different symbol (fourth aspect).

The transmission signal generating section 302 generates a downlink signal (such as a downlink control signal, a downlink data signal or a downlink reference signal) based on an instruction from the control section 301, and outputs the downlink signal to the mapping section 303. The transmission signal generating section 302 can be composed of a signal generator, a signal generating circuit or a signal generating apparatus described based on the common knowledge in the technical field according to the present invention.

The transmission signal generating section 302 generates, for example, a DL assignment for indicating downlink signal allocation information, and a UL grant for indicating uplink signal allocation information based on the instruction from the control section 301. Furthermore, the transmission signal generating section 302 performs encoding processing and modulation processing on a downlink data signal according to a code rate and a modulation scheme determined based on Channel State Information (CSI) from each user terminal 20.

The mapping section 303 maps the downlink signal generated by the transmission signal generating section 302, on a given radio resource based on the instruction from the control section 301, and outputs the downlink signal to each transmission/reception section 103. The mapping section 303 can be composed of a mapper, a mapping circuit or a mapping apparatus described based on the common knowledge in the technical field according to the present invention.

The received signal processing section 304 performs reception processing (e.g., demapping, demodulation and decoding) on a received signal input from each transmission/reception section 103. In this regard, the received signal is, for example, an uplink signal (such as an uplink control signal, an uplink data signal or an uplink reference signal) transmitted from the user terminal 20. The received signal processing section 304 can be composed of a signal processor, a signal processing circuit or a signal processing apparatus described based on the common knowledge in the technical field according to the present invention.

The received signal processing section 304 outputs information decoded by the reception processing to the control section 301. When, for example, receiving the PUCCH including HARQ-ACK, the received signal processing section 304 outputs the HARQ-ACK to the control section 301. Furthermore, the received signal processing section 304 outputs the received signal and the signal after the reception processing to the measurement section 305.

The measurement section 305 performs measurement related to the received signal. The measurement section 305 can be composed of a measurement instrument, a measurement circuit or a measurement apparatus described based on the common knowledge in the technical field according to the present invention.

The measurement section 305 may measure, for example, received power (e.g., Reference Signal Received Power (RSRP)), received quality (e.g., Reference Signal Received Quality (RSRQ) or a Signal to Interference plus Noise Ratio (SINR)) and/or a channel state of the received signal. The measurement section 305 may output a measurement result to the control section 301.

<User Terminal>

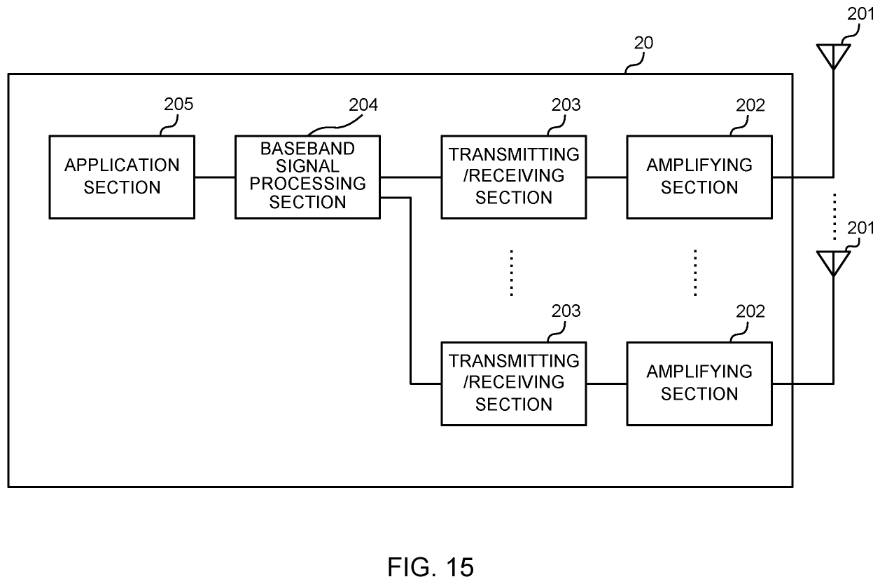

FIG. 15 is a diagram illustrating one example of an overall configuration of the user terminal according to the present embodiment. The user terminal 20 includes pluralities of transmission/reception antennas 201, amplifying sections 202 and transmission/reception sections 203, a baseband signal processing section 204 and an application section 205. In this regard, the user terminal 20 only needs to be configured to include one or more of each of the transmission/reception antennas 201, the amplifying sections 202 and the transmission/reception sections 203.

Each amplifying section 202 amplifies a radio frequency signal received at each transmission/reception antenna 201. Each transmission/reception section 203 receives a downlink signal amplified by each amplifying section 202. Each transmission/reception section 203 performs frequency conversion on the received signal into a baseband signal, and outputs the baseband signal to the baseband signal processing section 204. The transmission/reception sections 203 can be composed of transmitters/receivers, transmission/reception circuits or transmission/reception apparatuses described based on the common knowledge in the technical field according to the present invention. In this regard, the transmission/reception sections 203 may be composed as an integrated transmission/reception section or may be composed of transmission sections and reception sections.

The baseband signal processing section 204 performs at least one of FFT processing, error correcting decoding, and reception processing of retransmission control on the input baseband signal. The baseband signal processing section 204 transfers downlink user data to the application section 205. The application section 205 performs processing related to layers higher than a physical layer and an MAC layer. Furthermore, the baseband signal processing section 204 may transfer broadcast information of the downlink data, too, to the application section 205.

On the other hand, the application section 205 inputs uplink user data to the baseband signal processing section 204. The baseband signal processing section 204 performs transmission processing of retransmission control (e.g., HARQ transmission processing), channel coding, precoding, Discrete Fourier Transform (DFT) processing and IFFT processing on the uplink user data, and transfers the uplink user data to each transmission/reception section 203. Each transmission/reception section 203 converts the baseband signal output from the baseband signal processing section 204 into a radio frequency band, and transmits a radio frequency signal. The radio frequency signal subjected to the frequency conversion by each transmission/reception section 203 is amplified by each amplifying section 202, and is transmitted from each transmission/reception antenna 201.

In addition, each transmission/reception section 203 may further include an analog beam forming section that performs analog beam forming. The analog beam forming section can be composed of an analog beam forming circuit (e.g., a phase shifter or a phase shift circuit) or an analog beam forming apparatus (e.g., a phase shifter) described based on the common knowledge in the technical field according to the present invention. Furthermore, each transmission/reception antenna 201 can be composed of an array antenna, for example.

Each transmission/reception section 203 receives the synchronization signal block including the synchronization signal and the broadcast channel. Furthermore, each transmission/reception section 203 receives the Demodulation Reference Signal (DMRS) arranged in the same time-domain as that of the broadcast channel.

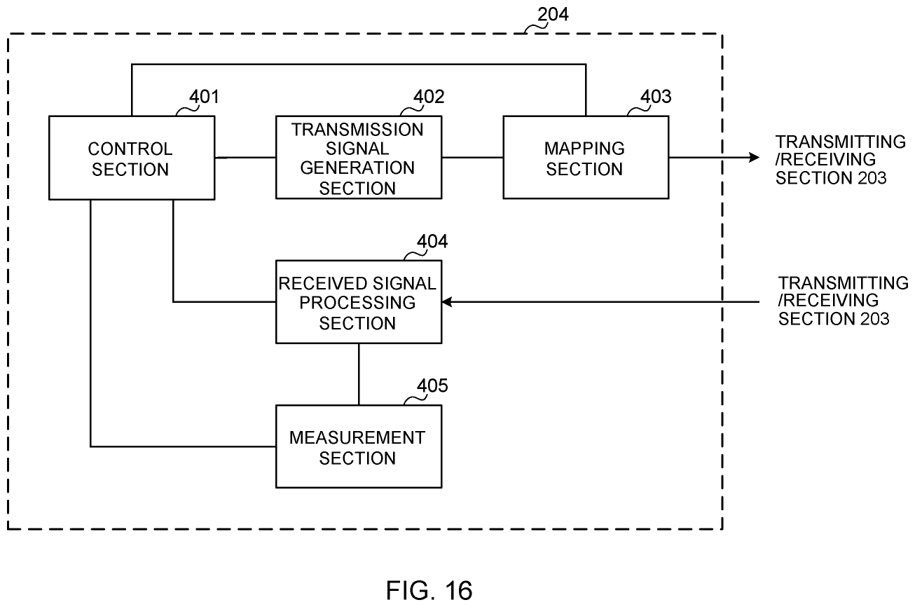

FIG. 16 is a diagram illustrating one example of a function configuration of the user terminal according to the present embodiment. In addition, this example mainly illustrates function blocks of characteristic portions according to the present embodiment, and assumes that the user terminal 20 includes other function blocks, too, that are necessary for radio communication.

The baseband signal processing section 204 of the user terminal 20 includes at least a control section 401, a transmission signal generating section 402, a mapping section 403, a received signal processing section 404 and a measurement section 405. In addition, these components only need to be included in the user terminal 20, and part or all of the components do not necessarily need to be included in the baseband signal processing section 204.

The control section 401 controls the entire user terminal 20. The control section 401 can be composed of a controller, a control circuit or a control apparatus described based on the common knowledge in the technical field according to the present invention.

The control section 401 controls, for example, signal generation of the transmission signal generating section 402 and signal allocation of the mapping section 403. Furthermore, the control section 401 controls signal reception processing of the received signal processing section 404 and signal measurement of the measurement section 405.

The control section 401 performs control to receive synchronization signal blocks at a given frequency band or more. Furthermore, the control section 401 may control reception of the synchronization signal blocks assuming that the synchronization signal blocks are arranged in a given domain of a slot.

The control section 401 controls specifying (or obtaining) of the SS block identification information based on the DMRS multiplexed on a plurality of symbols for the broadcast channel (NR-PBCH) in the SS block. More specifically, the control section 401 may specify the SS block identification information based on a DMRS sequence of a first symbol generated based on the cell identification information for identifying the cell and part of the SS block identification information, and a DMRS sequence of a second symbol generated based on the cell identification information and the other part of the SS block identification information (first aspect).

Furthermore, the SS block identification information may be specified based on DMRS sequences to be arranged on three or more symbols (third aspect).

Furthermore, the control section 401 may specify the SS block identification information from the DMRS sequences on a plurality of symbols and, in addition, the frequency positions (subcarrier shift) of these DMRS sequences (second aspect).

Furthermore, the control section 401 may verify (check) whether or not the DMRS sequences of the first and second symbols have been able to be correctly received based on the DMRS sequences arranged on symbols other than the above first and second symbols (fourth aspect).

Furthermore, the control section 401 may specify at least part of the SS block identification information based on at least one of the DMRS sequence of a different symbol for the NR-PBCH, a mapping pattern and the frequency position (subcarrier shift).

Furthermore, the control section 401 may derive a time index based on the specified SS block identification information.

The transmission signal generating section 402 generates an uplink signal (such as an uplink control signal, an uplink data signal and an uplink reference signal) based on an instruction from the control section 401, and outputs the uplink signal to the mapping section 403. The transmission signal generating section 402 can be composed of a signal generator, a signal generating circuit or a signal generating apparatus described based on the common knowledge in the technical field according to the present invention.

The transmission signal generating section 402 generates an uplink control signal related to transmission acknowledgement information and/or Channel State Information (CSI) based on, for example, the instruction from the control section 401. Furthermore, the transmission signal generating section 402 generates an uplink data signal based on the instruction from the control section 401. When, for example, the downlink control signal indicated from the radio base station 10 includes a UL grant, the transmission signal generating section 402 is instructed by the control section 401 to generate an uplink data signal.

The mapping section 403 maps the uplink signal generated by the transmission signal generating section 402, on a radio resource based on the instruction from the control section 401, and outputs the uplink signal to each transmission/reception section 203. The mapping section 403 can be composed of a mapper, a mapping circuit or a mapping apparatus described based on the common knowledge in the technical field according to the present invention.

The received signal processing section 404 performs reception processing (e.g., demapping, demodulation and decoding) on the received signal input from each transmission/reception section 203. In this regard, the received signal is, for example, a downlink signal (such as a downlink control signal, a downlink data signal and a downlink reference signal) transmitted from the radio base station 10. The received signal processing section 404 can be composed of a signal processor, a signal processing circuit or a signal processing apparatus described based on the common knowledge in the technical field according to the present invention. Furthermore, the received signal processing section 404 can compose the reception section according to the present invention.

The received signal processing section 404 receives a synchronization signal and a broadcast channel transmitted by the radio base station by applying beam forming based on an instruction from the control section 401. Particularly, the received signal processing section 404 receives the synchronization signal and the broadcast channel allocated to at least one of a plurality of time-domains (e.g., symbols) that compose a given transmission time interval (e.g., a subframe or a slot).

The received signal processing section 404 outputs information decoded by reception processing to the control section 401. The received signal processing section 404 outputs, for example, broadcast information, system information, an RRC signaling and DCI to the control section 401. Furthermore, the received signal processing section 404 outputs a received signal and a signal after the reception processing to the measurement section 405.

The measurement section 405 performs measurement related to the received signal. For example, the measurement section 405 performs measurement by using a beam forming RS transmitted from the radio base station 10. The measurement section 405 can be composed of a measurement instrument, a measurement circuit or a measurement apparatus described based on the common knowledge in the technical field according to the present invention.

The measurement section 405 may measure, for example, received power (e.g., RSRP), received quality (e.g., RSRQ or a received SINR) and/or a channel state of the received signal. The measurement section 405 may output a measurement result to the control section 401. For example, the measurement section 405 performs RRM measurement that uses a synchronization signal.

<Hardware Configuration>

In addition, the block diagrams used to describe the above embodiment illustrate blocks in function units. These function blocks (components) are realized by an optional combination of hardware and/or software. Furthermore, means for realizing each function block is not limited in particular. That is, each function block may be realized by one physically and/or logically coupled apparatus or may be realized by a plurality of these apparatuses formed by connecting two or more physically and/or logically separate apparatuses directly and/or indirectly (by way of, for example, wired connection and/or radio connection).

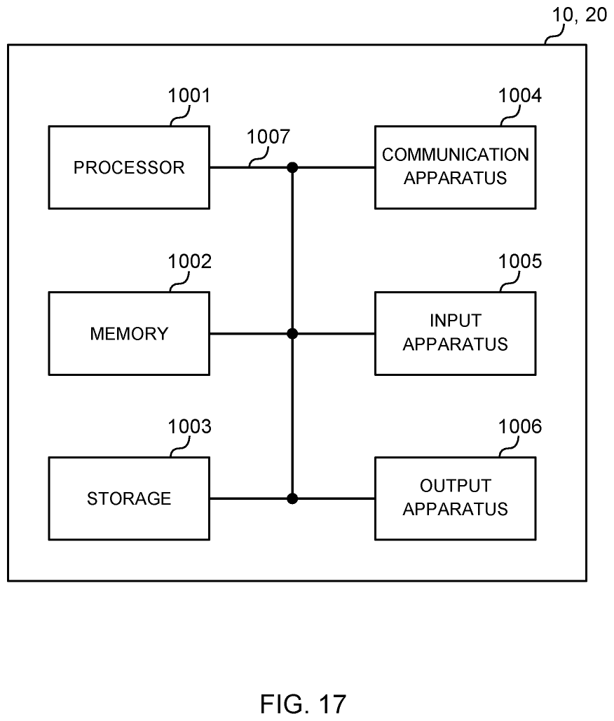

For example, the radio base station and the user terminal according to the present embodiment may function as computers that perform processing of the radio communication method according to the present invention. FIG. 17 is a diagram illustrating one example of the hardware configurations of the radio base station and the user terminal according to the present embodiment. The above radio base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, a word “apparatus” in the following description can be read as a circuit, a device or a unit. The hardware configurations of the radio base station 10 and the user terminal 20 may be configured to include one or a plurality of apparatuses illustrated in FIG. 17 or may be configured without including part of the apparatuses.

For example, FIG. 17 illustrates the only one processor 1001. However, there may be a plurality of processors. Furthermore, processing may be executed by one processor or processing may be executed by one or more processors concurrently, successively or by another method. In addition, the processor 1001 may be implemented by one or more chips.

Each function of the radio base station 10 and the user terminal 20 is realized by, for example, causing hardware such as the processor 1001 and the memory 1002 to read given software (program), and thereby causing the processor 1001 to perform an operation, and control at least one of communication of the communication apparatus 1004 and reading and writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, the above baseband signal processing section 104 (204) and call processing section 105 may be realized by the processor 1001.

Furthermore, the processor 1001 reads programs (program codes), a software module or data from the storage 1003 and/or the communication apparatus 1004 out to the memory 1002, and executes various types of processing according to these programs, software module or data. As the programs, programs that cause the computer to execute at least part of the operations described in the above embodiment are used. For example, the control section 401 of the user terminal 20 may be realized by a control program that is stored in the memory 1002 and operates on the processor 1001, and other function blocks may be also realized likewise.

The memory 1002 is a computer-readable recording medium, and may be composed of at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as a register, a cache or a main memory (main storage apparatus). The memory 1002 can store programs (program codes) and a software module that can be executed to carry out the radio communication method according to the one embodiment of the present invention.

The storage 1003 is a computer-readable recording medium, and may be composed of at least one of, for example, a flexible disk, a floppy (registered trademark) disk, a magnetooptical disk (e.g., a compact disk (Compact Disc ROM (CD-ROM)), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via wired and/or radio networks, and is also referred to as, for example, a network device, a network controller, a network card and a communication module. The communication apparatus 1004 may be configured to include a high frequency switch, a duplexer, a filter and a frequency synthesizer to realize, for example, Frequency Division Duplex (FDD) and/or Time Division Duplex (TDD). For example, the above transmission/reception antennas 101 (201), amplifying sections 102 (202), transmission/reception sections 103 (203) and channel interface 106 may be realized by the communication apparatus 1004.

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. In addition, the input apparatus 1005 and the output apparatus 1006 may be an integrated component (e.g., touch panel).

Furthermore, each apparatus illustrated in FIG. 17 is connected by the bus 1007 that communicates information. The bus 1007 may be composed of a single bus or may be composed of buses that are different between apparatuses.

Furthermore, the radio base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may realize part or all of each function block. For example, the processor 1001 may be implemented by at least one of these types of hardware.

### Modified Example

In addition, each term that has been described in this description and/or each term that is necessary to understand this description may be replaced with terms having identical or similar meanings. For example, a channel and/or a symbol may be signals (signaling). Furthermore, a signal may be a message. A reference signal can be also abbreviated as an RS (Reference Signal), or may be also referred to as a pilot or a pilot signal depending on standards to be applied. Furthermore, a Component Carrier (CC) may be referred to as a cell, a frequency carrier and a carrier frequency.

Furthermore, a radio frame may include one or a plurality of durations (frames) in a time-domain. Each of one or a plurality of durations (frames) that composes a radio frame may be referred to as a subframe. Furthermore, the subframe may include one or a plurality of slots in the time-domain. The subframe may be a fixed time duration (e.g., 1 ms) that does not depend on the numerologies.

The slot may include one or a plurality of symbols (Orthogonal Frequency Division Multiplexing (OFDM) symbols or Single Carrier-Frequency Division Multiple Access (SC-FDMA) symbols) in the time-domain. Furthermore, the slot may be a time unit based on the numerologies. Furthermore, the slot may include a plurality of mini slots. Each mini slot may include one or a plurality of symbols in the time-domain.

The radio frame, the subframe, the slot, the mini slot and the symbol each indicate a time unit for conveying signals. The other corresponding names may be used for the radio frame, the subframe, the slot, the mini slot and the symbol. For example, 1 subframe may be referred to as a Transmission Time Interval (TTI), a plurality of contiguous subframes may be referred to as TTIs, or 1 slot or 1 mini slot may be referred to as a TTI. That is, the subframe and/or the TTI may be a subframe (1 ms) according to legacy LTE, may be a duration (e.g., 1 to 13 symbols) shorter than 1 ms or may be a duration longer than 1 ms.

In this regard, the TTI refers to, for example, a minimum time unit of scheduling for radio communication. For example, in the LTE system, the radio base station performs scheduling for allocating radio resources (a frequency bandwidth and/or transmission power that can be used by each user terminal) in TTI units to each user terminal. In this regard, a definition of the TTI is not limited to this. The TTI may be a transmission time unit of a channel-coded data packet (transport block), or may be a processing unit of scheduling and/or link adaptation. In addition, when 1 slot or 1 mini slot is referred to as a TTI, 1 or more TTIs (i.e., 1 or more slots or 1 or more mini slots) may be a minimum time unit of scheduling. Furthermore, the number of slots (the number of mini slots) that compose a minimum time unit of the scheduling may be controlled.

The TTI having the time duration of 1 ms may be referred to as a general TTI (TTIs according to LTE Rel. 8 to 12), a normal TTI, a long TTI, a general subframe, a normal subframe or a long subframe. A TTI shorter than the general TTI may be referred to as a reduced TTI, a short TTI, a partial or fractional TTI, a reduced subframe or a short subframe.

Resource Blocks (RBs) are resource allocation units of the time-domain and the frequency-domain, and may include one or a plurality of contiguous subcarriers in the frequency-domain. Furthermore, the RB may include one or a plurality of symbols in the time-domain or may have the length of 1 slot, 1 mini slot, 1 subframe or 1 TTI. 1 TTI or 1 subframe may each include one or a plurality of resource blocks. In this regard, the RB may be referred to as a Physical Resource Block (PRB: Physical RB), a PRB pair or an RB pair.

Furthermore, the resource block may include one or a plurality of Resource Elements (REs). For example, 1 RE may be a radio resource domain of 1 subcarrier and 1 symbol.

In this regard, structures of the above radio frame, subframe, slot, mini slot and symbol are only exemplary structures. For example, configurations such as the number of subframes included in a radio frame, the number of slots per subframe or radio frame, the number of mini slots included in a slot, the number of symbols included in a slot or a mini slot, the number of subcarriers included in an RB, the number of symbols in a TTI, a symbol length and a Cyclic Prefix (CP) length can be variously changed.

Furthermore, the information and parameters described in this description may be expressed by absolute values, may be expressed by relative values with respect to given values or may be expressed by other corresponding information. For example, a radio resource may be instructed by a given index. Furthermore, numerical expressions that use these parameters may be different from those explicitly disclosed in this description.

Names used for parameters in this description are in no respect restrictive ones. For example, various channels (the Physical Uplink Control Channel (PUCCH) and the Physical Downlink Control Channel (PDCCH)) and information elements can be identified based on various suitable names. Therefore, various names assigned to these various channels and information elements are in no respect restrictive ones.

The information and the signals described in this description may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or optional combinations of these.

Furthermore, the information and the signals can be output from a higher layer to a lower layer and/or from the lower layer to the higher layer. The information and the signals may be input and output via a plurality of network nodes.

The input and output information and signals may be stored in a specific location (e.g., memory) or may be managed by a management table. The information and signals to be input and output can be overwritten, updated or additionally written. The output information and signals may be deleted. The input information and signals may be transmitted to other apparatuses.

Indication of information is not limited to the aspects/embodiment described in this description and may be performed by other methods. For example, the information may be notified by a physical layer signaling (e.g., Downlink Control Information (DCI) and Uplink Control Information (UCI)), a higher layer signaling (e.g., a Radio Resource Control (RRC) signaling, broadcast information (Master Information Blocks (MIBs) and System Information Blocks (SIBs)), and a Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnectionReconfiguration message. Furthermore, the MAC signaling may be indicated by, for example, an MAC Control Element (MAC CE).

Furthermore, indication of given information (e.g., indication of “being X”) may be made not only explicitly but also implicitly (by, for example, not indicating this given information or by indicating another information).

Decision may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using wired techniques (e.g., coaxial cables, optical fiber cables, twisted pairs and Digital Subscriber Lines (DSL)) and/or radio techniques (e.g., infrared rays and microwaves), these wired techniques and/or radio techniques are included in a definition of the transmission media.

The terms “system” and “network” used in this description are compatibly used.

In this description, the terms “Base Station (BS)”, “radio base station”, “eNB”, “gNB”, “cell”, “sector”, “cell group”, “carrier” and “component carrier” can be compatibly used. The base station is also referred to as a term such as a fixed station, a NodeB, an eNodeB (eNB), an access point, a transmission point, a reception point, a femtocell or a small cell in some cases.

The base station can accommodate one or a plurality of (e.g., three) cells (also referred to as sectors). When the base station accommodates a plurality of cells, an entire coverage area of the base station can be partitioned into a plurality of smaller areas. Each smaller area can also provide communication service via a base station subsystem (e.g., indoor small base station (RRH: Remote Radio Head)). The term “cell” or “sector” indicates part or the entirety of the coverage area of the base station and/or the base station subsystem that provide communication service in this coverage.

In this description, the terms “Mobile Station (MS)”, “user terminal”, “User Equipment (UE)” and “terminal” can be compatibly used. The base station is also referred to as a term such as a fixed station, a NodeB, an eNodeB (eNB), an access point, a transmission point, a reception point, a femtocell or a small cell in some cases.

The mobile station is also referred to by a person skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

Furthermore, the radio base station in this description may be read as the user terminal. For example, each aspect/embodiment of the present invention may be applied to a configuration where communication between the radio base station and the user terminal is replaced with communication between a plurality of user terminals (D2D: Device-to-Device). In this case, the user terminal 20 may be configured to include the functions of the above radio base station 10. Furthermore, “uplink” and/or “downlink” may be read as a “side”. For example, the uplink channel may be read as a side channel.

Similarly, the user terminal in this description may be read as the radio base station. In this case, the radio base station 10 may be configured to include the functions of the above user terminal 20.

In this description, specific operations performed by the base station are performed by an upper node of this base station depending on cases. Obviously, in a network including one or a plurality of network nodes including the base stations, various operations performed to communicate with a terminal can be performed by base stations, one or more network nodes (that are supposed to be, for example, Mobility Management Entities (MME) or Serving-Gateways (S-GW) yet are not limited to these) other than the base stations or a combination of these.

Each aspect/embodiment described in this description may be used alone, may be used in combination or may be switched and used when carried out. Furthermore, orders of the processing procedures, the sequences and the flowchart according to each aspect/embodiment described in this description may be rearranged unless contradictions arise. For example, the method described in this description presents various step elements in an exemplary order and is not limited to the presented specific order.

Each aspect/embodiment described in this description may be applied to Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), Future Radio Access (FRA), the New Radio Access Technology (New-RAT), New Radio (NR), New radio access (NX), Future generation radio access (FX), Global System for Mobile communications (GSM) (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideB and (UWB), Bluetooth (registered trademark), systems that use other appropriate radio communication methods and/or next-generation systems that are expanded based on these systems.

The phrase “based on” used in this description does not mean “based only on” unless specified otherwise. In other words, the phrase “based on” means both of “based only on” and “based at least on”.

Every reference to elements that use names such as “first” and “second” used in this description does not generally limit the quantity or the order of these elements. These names can be used in this description as a convenient method for distinguishing between two or more elements. Hence, the reference to the first and second elements does not mean that only two elements can be employed or the first element should precede the second element in some way.

The term “deciding (determining)” used in this description includes diverse operations in some cases. For example, “deciding (determining)” may be regarded to “decide (determine)” calculating, computing, processing, deriving, investigating, looking up (e.g., looking up in a table, a database or another data structure) and ascertaining. Furthermore, “deciding (determining)” may be regarded to “decide (determine)” receiving (e.g., receiving information), transmitting (e.g., transmitting information), input, output and accessing (e.g., accessing data in a memory). Furthermore, “deciding (determining)” may be regarded to “decide (determine)” resolving, selecting, choosing, establishing and comparing. That is, “deciding (determining)” may be regarded to “decide (determine)” some operation.

The words “connected” and “coupled” used in this description or every modification of these words can mean every direct or indirect connection or coupling between two or more elements, and can include that one or more intermediate elements exist between the two elements “connected” or “coupled” with each other. The elements may be coupled or connected physically, logically or by way of a combination of the physical and logical connections. It can be understood that, when used in this description, the two elements are “connected” or “coupled” with each other by using one or more electric wires, cables and/or printed electrical connection, and by using electromagnetic energy having wavelengths in radio frequency-domains, microwave domains and (both of visible and invisible) light domains in some non-restrictive and non-comprehensive examples.

When the words “including” and “comprising” and modifications of these words are used in this description or the claims, these words intend to be comprehensive similar to the word “having”. Furthermore, the word “or” used in this description or the claims intends not to be an XOR.

The present invention has been described in detail above. However, it is obvious for a person skilled in the art that the present invention is not limited to the embodiment described in this description. The present invention can be carried out as modified and changed aspects without departing from the gist and the scope of the present invention defined by the recitation of the claims. Accordingly, the disclosure of this description intends for exemplary explanation, and does not have any restrictive meaning to the present invention.

1. A user terminal comprising:
a reception section that receives a Synchronization Signal (SS) block including a synchronization signal and a broadcast channel; and
a control section that specifies SS block identification information based on at least a sequence of a first reference signal and a sequence of a second reference signal, the sequence of the first reference signal being a sequence to be allocated to a first symbol, and being generated based on cell identification information for identifying a cell, and a first part of the SS block identification information for identifying the SS block, and the sequence of the second reference signal being a sequence to be allocated to a second symbol, being generated based on the cell identification information for identifying the cell, and a second part of the SS block identification information, and being different from the sequence of the first reference signal.

2. The user terminal according to claim 1, wherein the first and second reference signals are each arranged at a frequency position of each of the first and second symbols based on a third part different from the first part and the second other part of the SS block identification information.

3. The user terminal according to claim 1, wherein the first and second reference signals are arranged at a same frequency position between the first and second symbols.

4. The user terminal according to claim 1, wherein a sequence of a demodulation reference signal of the broadcast channel allocated to a third symbol in the SS block is based on a result obtained by performing given operation processing on the sequences of the first and second reference signals.

5. A radio communication method comprising at a user terminal:
receiving a Synchronization Signal (SS) block including a synchronization signal and a broadcast channel; and
specifying SS block identification information based on at least a sequence of a first reference signal and a sequence of a second reference signal, the sequence of the first reference signal being a sequence to be allocated to a first symbol, and being generated based on cell identification information for identifying a cell, and a first part of the SS block identification information for identifying the SS block, and the sequence of the second reference signal being a sequence to be allocated to a second symbol, being generated based on the cell identification information for identifying the cell, and a second part of the SS block identification information, and being different from the sequence of the first reference signal.

6. The user terminal according to claim 2, wherein the first and second reference signals are arranged at a same frequency position between the first and second symbols.

7. The user terminal according to claim 2, wherein a sequence of a demodulation reference signal of the broadcast channel allocated to a third symbol in the SS block is based on a result obtained by performing given operation processing on the sequences of the first and second reference signals.

8. The user terminal according to claim 3, wherein a sequence of a demodulation reference signal of the broadcast channel allocated to a third symbol in the SS block is based on a result obtained by performing given operation processing on the sequences of the first and second reference signals.
